(19) United States
(12) Patent Application Publication
(10) Pub. No.: US 2026/0142521 A1
(43) Pub. Date: May 21, 2026

(54) COIL UNIT, ARMATURE, AND ROTATING ELECTRICAL MACHINE

(71) Applicant: DENSO CORPORATION, Kariya-city (JP)

(72) Inventors: Yuji HAYASHI, Kariya-city (JP); Shinji MAKITA, Kariya-city (JP); Keisuke KOIDE, Kariya-city (JP); Yusuke TATEISHI, Kariya-city (JP)

(73) Assignee: DENSO CORPORATION, Kariya-city (JP)

(21) Appl. No.: 19/448,732

(22) Filed: Jan. 14, 2026

Related U.S. Application Data
(63) Continuation of application No. PCT/JP2024/019418, filed on May 27, 2024.

(30) Foreign Application Priority Data
Aug. 9, 2023 (JP) 2023-130444

(51) Int. Cl. H02K 3/34; H02K 3/28

(52) U.S. Cl. CPC H02K 3/34; H02K 3/28; H02K 2203/09

(57) ABSTRACT

A coil unit includes a plurality of substrates stacked on one another in an axial direction of the coil unit, and a plurality of conductor layers respectively formed on the substrates. The coil unit further includes a first series-connecting conductor that connects in series a first conductor layer formed on a first substrate and a first conductor layer formed on a second substrate. The coil unit further includes a second series-connecting conductor that connects in series a second conductor layer formed on the first substrate and a second conductor layer formed on the second substrate. The coil unit further includes a parallel-connecting conductor that connects in parallel the conductor layers connected by the first series-connecting conductor and the conductor layers connected by the second series-connecting conductor.

### CROSS REFERENCE TO RELATED DOCUMENT

The present application claims the benefit of priority of Japanese Patent Application No. 2023-130444 filed on Aug. 9, 2023, the disclosure of which is incorporated in its entirety herein by reference.

### TECHNICAL FIELD

This disclosure generally relates to a coil unit, an armature, and a rotating electrical machine.

### BACKGROUND ART

Japanese Patent First Publication No. 2008-061357 discloses a coil for use in a rotating electrical machine, such as an electrical motor. The coil includes a plurality of disc-shaped coil plate segments, each having a predetermined wiring pattern formed thereon. In addition, each of the coil plate segments has an intermediate portion between outer and inner peripheries thereof. The coil plate segments are joined together at their inner and outer peripheries, with the intermediate portions being spaced apart from each other, thereby forming a coil plate having a predetermined coil winding pattern.

### PRIOR ART DOCUMENT

### Patent Literature

FIRST PATENT LITERATURE: Japanese Patent First Publication No. 2008-061357

### SUMMARY OF THE INVENTION

In recent years, higher efficiency and higher torque have been desired in rotary electric machines; however, the configuration described in the first patent literature still has room for improvement in this respect.

It is an object of this disclosure to provide a coil unit, an armature, and a rotating electrical machine that achieve higher efficiency and higher torque in a configuration in which base members are stacked on one another in an axial direction thereof.

According to one aspect of this disclosure, there is provided a coil unit which comprises: (a) a plurality of base members each of which is made of an insulating material and has a shape extending in a radial direction of the coil unit, the base members being stacked on one another in an axial direction of the coil unit; (b) a plurality of conductor layers which are made of a conductive material and respectively formed on the base members; (c) a first series-connecting conductor which connects a first conductor layer that is one of the conductor layers and formed on a first base member and a first conductor layer that is one of the conductor layers and formed on a second base member in series with each other, the first base member being one of the base members, the second base member being one of the base members; (d) a second series-connecting conductor which connects a second conductor layer that is one of the conductor layers and formed on the first base member and a second conductor layer that is one of the conductor layers and formed on the second base member in series with each other; and (e) parallel-connecting conductors which connect, in parallel, the conductor layers connected together by the first series-connecting conductor with the conductor layers connected together by the second series-connecting conductor.

According to the second aspect of this disclosure, there is provided a coil unit which comprises: (a) a plurality of base members each of which is made of an insulating material and has a shape extending in a radial direction of the coil unit, the base members being stacked on one another in an axial direction of the coil unit; (b) a plurality of conductor layers which are made of a conductive material and respectively formed on the base members; (c) a first series-connecting conductor which connects, in series, a plurality of conductor layers that are some of the conductor layers, connected in parallel with each other, and formed on a first base member, to a plurality of conductor layers that are some of the conductor layers, connected in parallel with each other, and formed on a second base member, the first base member being one of the base members, the second base member being one of the base members; (d) a second series-connecting conductor which connects, in series, a plurality of conductor layers that are some of the conductor layers, connected in parallel with each other, and formed on a third base member, to a plurality of conductor layers that are some of the conductor layers, connected in parallel with each other, and formed on a fourth base member, the third base member being one of the base members, the fourth base member being one of the base members; and (e) parallel-connecting conductors (52) which connect, in parallel, the conductor layers connected together by the first series-connecting conductor with the conductor layers connected together by the second series-connecting conductor.

According to the third aspect of this disclosure, there is provided an armature comprising one of the coil units described above.

According to the fourth aspect of this disclosure, there is provided a rotating electrical machine which comprises a first one of a stator and a rotor, which includes the above-described armature, and a second one of the stator and the rotor which includes a magnet facing the coil unit in the axial direction.

The above-described structure is capable of achieving higher efficiency and higher torque in a configuration in which base members are stacked on one another in an axial direction thereof.

### BRIEF DESCRIPTION OF THE DRAWINGS

The above-described object, other objects, features, or beneficial advantages in this disclosure will be apparent from the following detailed discussion with reference to the drawings.

In the drawings:

FIG. 1 is a perspective view showing a motor, with a portion of the motor shown in a cutaway manner;

FIG. 2 is an exploded perspective view showing a motor in a disassembled state, with some components shown in a cutaway manner;

FIG. 3 is an exploded perspective view showing a coil body in a disassembled state, with a portion of the coil body shown in a cutaway manner;

FIG. 4 is a plan view schematically showing a coil unit;

FIG. 5 is a diagram for explaining a star connection;

FIG. 6 is a plan view schematically showing one substrate and a coil segment formed on the substrate;

FIG. 7 is a cross-sectional view showing a part of a substrate of a specific layer and a coil segment formed on the substrate of a coil unit of a motor;

FIG. 8 is a cross-sectional view showing parts of substrates of a plurality of layers and coil segments formed on the respective substrates of a coil unit of a motor;

FIG. 9 is a cross-sectional view schematically showing a motor according to the first embodiment;

FIG. 10 is a cross-sectional view schematically showing a coil unit of a motor according to the first embodiment.

FIG. 11 is a block diagram showing a connection state of conductor layers;

FIG. 12 is a block diagram showing a connection state of conductor layers;

FIG. 13 is a cross-sectional view schematically showing a motor according to the second embodiment;

FIG. 14 is a cross-sectional view schematically showing a coil unit of a motor according to the second embodiment;

FIG. 15 is a block diagram showing a connection state of conductor layers;

FIG. 16A is a block diagram showing a connection state of conductor layers;

FIG. 16B is a cross-sectional view schematically showing a coil unit of a motor;

FIG. 17 is a cross-sectional view schematically showing a motor according to the third embodiment;

FIG. 18 is a block diagram showing a connection state of conductor layers;

FIG. 19 is a block diagram showing a connection state of conductor layers;

FIG. 20 is a cross-sectional view schematically showing a motor in which the number of stacked substrates is six;

FIG. 21 is a block diagram showing a connection state of conductor layers;

FIG. 22 is a block diagram showing a connection state of conductor layers;

FIG. 23 is a cross-sectional view schematically showing a motor according to the fourth embodiment;

FIG. 24 is a cross-sectional view schematically showing a motor in which a connection state of conductor layers has been changed for the motor of the fourth embodiment;

FIG. 25 is a perspective view schematically showing a coil unit of a motor according to the fifth embodiment, illustrating a state before a first substrate and a second substrate are stacked on one another;

FIG. 26 is a plan view schematically showing a coil unit of a motor according to the fifth embodiment, illustrating a state before a first substrate and a second substrate are stacked on one another;

FIG. 27 is a plan view schematically showing a coil unit of a motor according to the fifth embodiment, illustrating a state in which a first substrate and a second substrate are stacked on one another;

FIG. 28 is a perspective view schematically showing a coil unit of a motor according to the sixth embodiment, illustrating a state before a first substrate and a second substrate are stacked on one another;

FIG. 29 is a perspective view schematically showing a coil unit of a motor according to the sixth embodiment, illustrating a state in which a first substrate and a second substrate are stacked on one another;

FIG. 30 is a plan view schematically showing a coil unit of a motor according to the seventh embodiment, illustrating a state before a first substrate, a second substrate, and a third substrate are stacked on one another;

FIG. 31 is a plan view schematically showing a coil unit of a motor according to the seventh embodiment, illustrating a state in which a first substrate and a second substrate are stacked on one another;

FIG. 32 is a plan view schematically showing a coil unit of a motor according to the seventh embodiment, illustrating a state in which a first substrate, a second substrate, and a third substrate are stacked on one another;

FIG. 33 is a perspective view schematically showing a coil unit of a motor according to the eighth embodiment, illustrating a state before a first substrate, a second substrate, and a third substrate are stacked on one another;

FIG. 34 is a perspective view schematically showing a coil unit of a motor according to the eighth embodiment, illustrating a state in which a first substrate, a second substrate, and a third substrate are stacked on one another;

FIG. 35 is a plan view schematically showing a coil unit of a motor according to the eighth embodiment, illustrating a state before a first substrate, a second substrate, and a third substrate are stacked on one another;

FIG. 36 is a plan view schematically showing a coil unit of a motor according to the eighth embodiment, illustrating an intermediate state in a manufacturing process in which a first substrate, a second substrate, and a third substrate are stacked on one another;

FIG. 37 is a plan view schematically showing a coil unit of a motor according to the eighth embodiment, illustrating a state in which a first substrate, a second substrate, and a third substrate are stacked on one another;

FIG. 38 is a plan view showing a coil unit of a motor according to the ninth embodiment, illustrating a state before a first substrate and a second substrate are stacked on one another;

FIG. 39 is a plan view showing a coil unit of a motor according to the tenth embodiment, illustrating a state before a first substrate and a second substrate are stacked on one another;

FIG. 40 is a plan view showing a coil unit of a motor according to the eleventh embodiment, illustrating a state before a first substrate and a second substrate are stacked on one another;

FIG. 41 is a cross-sectional view showing parts of substrates of a plurality of layers and cross sections of coil segments formed on the respective substrates of a motor according to the eleventh embodiment;

FIG. 42 is a perspective view schematically showing a coil unit of a motor according to the twelfth embodiment, illustrating a state before a first substrate and a second substrate are stacked on one another;

FIG. 43 is a plan view schematically showing a coil unit of a motor according to the twelfth embodiment, illustrating a state in which a first substrate and a second substrate are stacked on one another;

FIG. 44 is a perspective view schematically showing a coil unit of a motor according to the thirteenth embodiment, illustrating a state before a first substrate and a second substrate are stacked on one another;

FIG. 45 is a plan view schematically showing a coil unit of a motor according to the thirteenth embodiment, illustrating a state in which a first substrate and a second substrate are stacked on one another;

FIG. 46 is a plan view schematically showing a first substrate constituting part of a coil unit of a motor according to the fourteenth embodiment;

FIG. 47 is a perspective view schematically showing a coil unit of a motor according to the fourteenth embodiment, illustrating a state in which a first substrate and a second substrate are stacked on one another;

FIG. 48 is a plan view schematically showing a first substrate constituting part of a coil unit of a motor according to the fifteenth embodiment;

FIG. 49 is a perspective view schematically showing a coil unit of a motor according to the fifteenth embodiment, illustrating a state in which a first substrate and a second substrate are stacked on one another; and

FIG. 50 is a perspective view schematically showing a coil unit of a motor according to the sixteenth embodiment, illustrating a state in which a plurality of substrates are stacked on one another.

### MODE FOR CARRYING OUT THE INVENTION

### Basic Structure of Motor

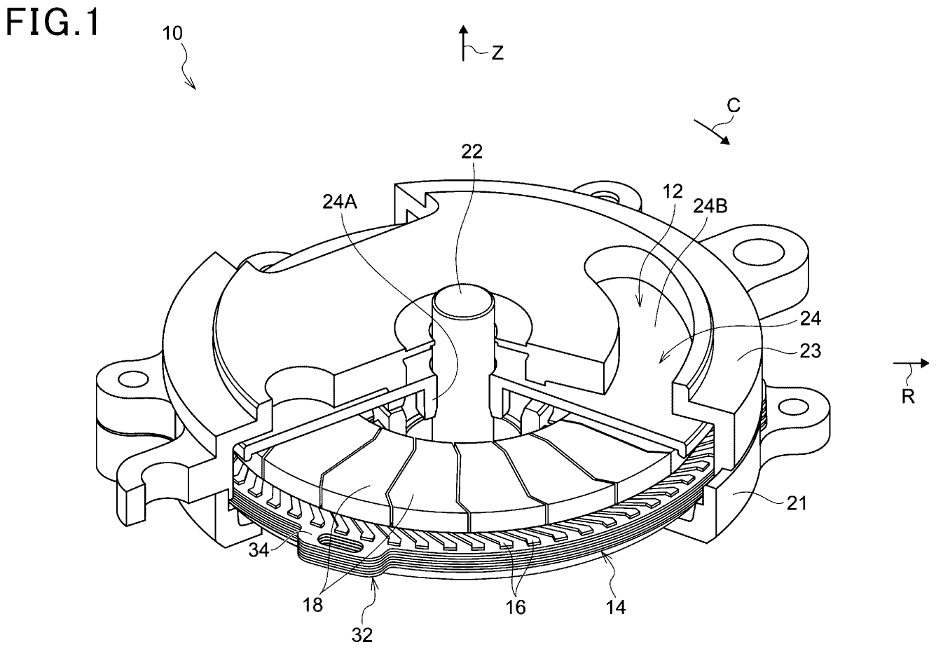

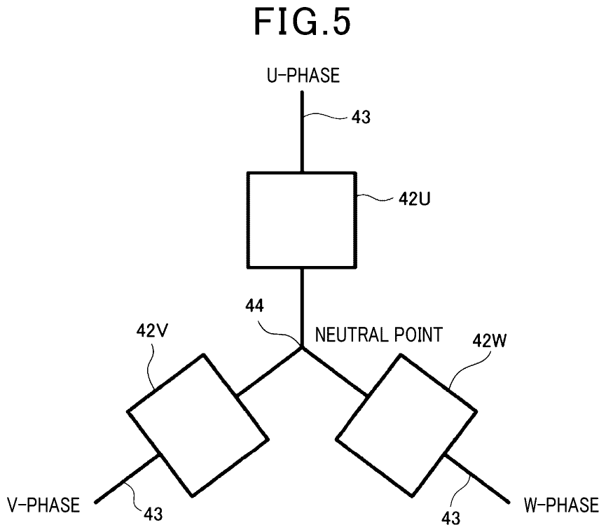

The basic configuration of the motor 10 according to an embodiment of this disclosure will be described below with reference to FIGS. 1 to 8. In the drawings, the arrow Z-direction, the arrow R-direction, and the arrow C-direction respectively indicate one axial side of the rotation axis, a radially outer side, and one circumferential direction side of the rotor 12 which will be described later in detail. In the following discussion, unless otherwise specified, the terms “axial direction,” “radial direction,” and “circumferential direction” respectively refer to the rotation axis direction, the radial direction, and the circumferential direction of the rotor 12. The motor 10 in this embodiment or following embodiments are examples of rotating electrical machines.

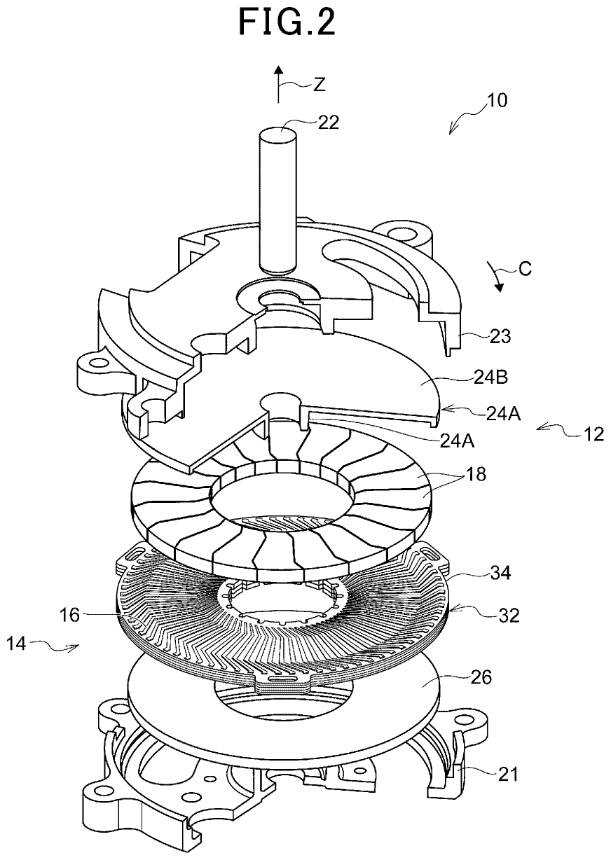

As shown in FIGS. 1 and 2, the motor 10 is implemented by an axial-gap type brushless motor in which the rotor 12 and the stator 14 serving as an armature are disposed to face each other in the axial direction. It should be noted that FIGS. 1 and 2 illustrate the motor 10 as being an example, and some portions may differ from the later description in the number of coil segments 16, the number of magnets 18, and in detailed shapes.

The rotor 12 includes the rotating shaft 22, the rotor core 24, and a plurality of magnets 18. The rotating shaft 22 is retained by a pair of bearings (not shown) to be rotatable. The rotor core 24 is secured to the rotating shaft 22. The rotor core 24 has a first surface and a second surface which are opposed to each other in the axial direction. The first surface faces in a first axial direction, while the second surface faces in a second axial direction opposite the first axial direction. The magnets 18 are attached to the second surface of the rotor core 24. The bearings are supported by the frame 21 and the frame end 23, respectively. The stator 14 is disposed between the frame 21 and the frame end 23.

The rotor core 24 has a cylindrical shape and includes the first cylinder 24A, to which the rotating shaft 22 is fixed by, for example, press-fitting, and the circular plate 24B that extends radially outward from one axial end (which will also be referred to below as a first axial end) of the first cylinder 24A. The circular plate 24B has a disk-like shape with its thickness extending in the axial direction. The magnets 18, which will be described later, are fixed to a surface of the circular plate 24B (which will also be referred to below as a second surface or a second axial surface facing in the second axial direction).

A plurality of the magnets 18 are formed of a magnetic compound having an intrinsic coercive force (Hc) of 400 kA/m or more and a remanent flux density (Br) of 1.0 T or more. As one example, the magnets 18 are formed of a magnetic compound such as NdFe₁₁TiN, Nd₂Fe₁₄B, Sm₂Fe₁₇N₃, or FeNi. In addition, the plurality of the magnets 18 are fixed to the second surface of the circular plate 24B of the rotor core 24. Furthermore, some of the magnets 18 which have their second axial surfaces, as facing in the second axial direction, magnetized as N poles and the remaining magnets 18 having their second axial surfaces magnetized as S poles are alternately arranged in the circumferential direction. The number of the magnets 18 may be appropriately set in consideration of the output and other requirements demanded of the motor 10.

The stator 14 includes the stator core 26 serving as an armature core, which is formed in an annular shape, and the coil unit 32 that is disposed on the first axial surface of the stator core 26. The stator 14 of the present embodiment has a toothless structure in which no portion of the stator core 26 is disposed between the coil segments 16 that constitute a part of the coil unit 32.

The stator core 26 is formed of a soft magnetic material such as steel. The stator core 26 has a plate shape with its thickness extending in the axial direction and is formed in an annular shape when viewed in the axial direction. The stator core 26 is disposed coaxially with the rotor 12. The stator core 26 is arranged to have the radial center thereof coinciding, in the radial direction, with the radial center of the array of the magnets 18 fixed to the rotor core 24.

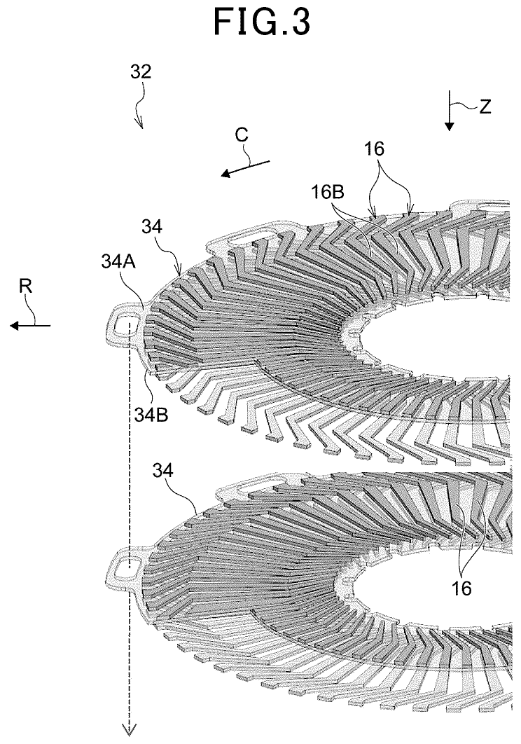

As shown in FIG. 3, the coil unit 32 is configured to include a plurality of the substrates 34 serving as base members, which are formed by an insulating material into a sheet shape, and a plurality of the coil segments 16 that are respectively formed on the substrates 34.

The substrates 34 are formed in a plate shape with their thickness directions extending in the axial direction and are formed in an annular shape when viewed in the axial direction. The substrates 34 may be flexible substrates that may be curved in their thickness directions, or may be substrates that may not be curved in their thickness directions. In the coil unit 32 of the present embodiment, a plurality of the substrates 34 are laminated or stacked on one another in the axial direction.

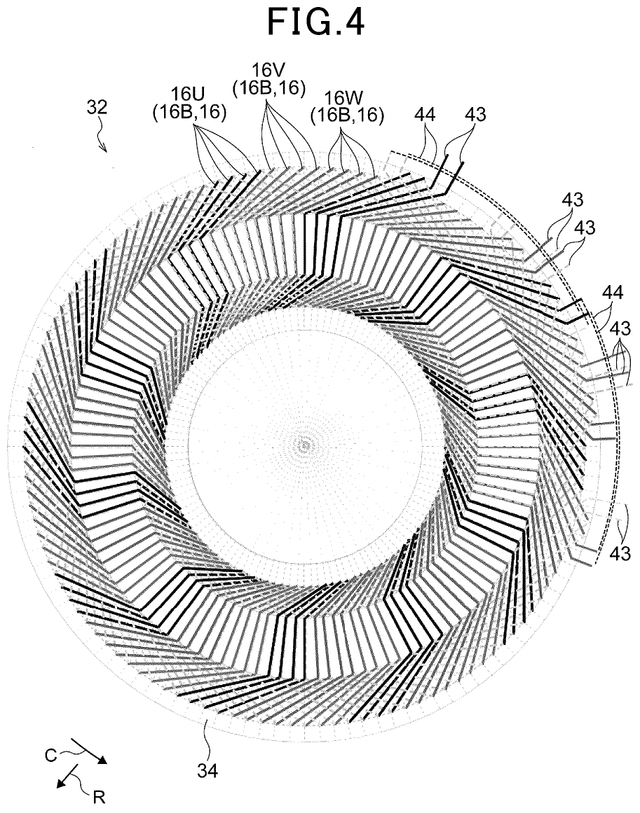

As shown in FIGS. 3 and 4, the coil segments 16 are formed on the substrates 34. The substrates 34 are stacked on one another in the axial direction in the form of multiple layers, so that the coil segments 16 are arranged at predetermined positions in the circumferential and axial directions.

The coil segments 16 includes U-phase coil segments (which will also be referred to below as a U-phase coil group 42U), V-phase coil segments (which will also be referred to below as a V-phase coil group 42V), and W-phase coil segments (which will be referred to below as a W-phase coil group 42W). The U-phase coil group 42U, the V-phase coil group 42V, and the W-phase coil group 42W are star-connected together. Specifically, the U-phase coil group 42U has the current input/output terminals 43 (which will also be referred to below as a first end) and a second end opposite to the first end. The V-phase coil group 42V has the current input/output terminals 43 (which will also be referred to below as a first end) and a second end opposite to the first end. Similarly, the W-phase coil group 42W has the current input/output terminals 43 (which will also be referred to below as a first end and a second end opposite to the first end. The second ends of the U-phase coil group 42U, the V-phase coil group 42V, and the W-phase coil group 42W are connected together through the neutral point 44.

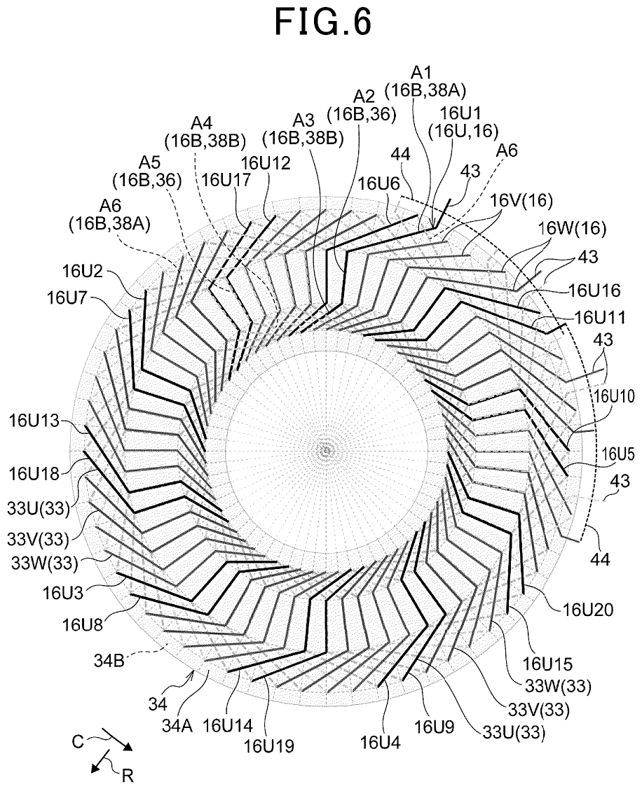

FIG. 6 demonstrates the first-layer substrate 34 and the coil segments 16 disposed on the first-layer substrate 34. On the first-layer of the substrates 34, twenty of the coil segments 16 constituting a U-phase, twenty of the coil segments 16 constituting a V-phase, and twenty of the coil segments 16 constituting a W-phase are arranged. In the following discussion, the coil segments 16 constituting the U-phase will also be referred to as coil segments 16U. The coil segments 16 constituting the V-phase will also be referred to as the coil segments 16V. The coil segments 16 constituting the W-phase will also be referred to as the coil segments 16W. In addition, the twenty coil segments 16U will also be referred to as the coil segment 16U1 to the coil segment 16U20. The twenty V-phase coil segments 16V will also be referred to as the coil segment 16V1 to the coil segments 16V20. The twenty coil segments 16W will also be referred to as the coil segment 16W1 to the coil segments 16W20.

Specifically, the coil segment 16U1 includes the first extending portion A1 that is inclined radially inward as it extends from the input/output terminal 43 in a first circumferential direction (i.e., a counterclockwise direction in FIG. 6) of the first-layer substrate 34, and the second extending portion A2 that extends radially inward from a second end of the first extending portion A1 which is opposite to the input/output terminal 43. The coil segment 16U1 also includes the third extending portion A3 and the fourth extending portion A4. The third extending portion A3 is inclined radially inward as it extends in the first circumferential direction from a second end of the second extending portion A2, which is opposite to the first end of the second extending portion A2 leading to the first extending portion A1. The fourth extending portion A4 is inclined radially outward as it extends in the first circumferential direction from a second end of the third extending portion A3, which is opposite to a first end of the third extending portion A3 leading to the second extending portion A2. Further, the coil segment 16U1 also includes the fifth extending portion A5 and the sixth extending portion A6. The fifth extending portion A5 extends radially outward from a second end of the fourth extending portion A4, which is opposite to a first end of the fourth extending portion A4 leading to the third extending portion A3. The sixth extending portion A6 is inclined radially outward as it extends in the first circumferential direction from a second end of the fifth extending portion A5, which is opposite to a first end of the fifth extending portion A5 leading to the fourth extending portion A4. In the following discussion, the first extending portion A1 to the sixth extending portion A6 will also be referred to as the conductor 16B. the coil unit 32 has the conductors 16B arranged at regular intervals away from each other in the circumferential direction thereof.

The first extending portion A1, the second extending portion A2, and the third extending portion A3 are formed on the surface 34A of the substrate 34 (i.e., the surface facing the stator core 26), while the fourth extending portion A4, the fifth extending portion A5, and the sixth extending portion A6 are formed on the surface 34B of the substrate 34 (i.e., the surface opposite to the surface 34A, that is, facing away from the stator core 26). The third extending portion A3 and the fourth extending portion A4 are electrically connected to each other through, for example, a via or a through hole (not shown). In FIG. 6, portions of the coil segment 16U1 formed on the surface 34A of the substrate 34 are shown by solid lines, whereas portions of the coil segment 16U1 formed on the surface 34B of the substrate 34 are shown by broken lines.

In the following discussion, each of the second extending portion A2 and the fifth extending portion A5 will also be referred to as the vertical portion 36. Each of the first extending portion A1 and the sixth extending portion A6 will also be referred to as the outer coil end portion 38A, which is one of coil ends of the coil unit 32, while each of the third extending portion A3 and the fourth extending portion A4 will also be referred to as the inner coil end portion 38B, which is the other coil end of the coil unit 32. Each of the coil segments 16 has the first extending portion A1 to the sixth extending portion A6, so that when viewed in the thickness direction of the substrates 34, the shape of the coil segment 16U1 becomes substantially V-shaped (or U-shaped), in which a radially outer portion of the coil segment 16U1 is open, while a radially inner portion of the coil segment 16U1 is closed.

Other coil segments, each of the coil segment 16U2 to 16U20 constituting the U-phase is configured in the same manner as the coil segment 16U1. That is, all of the coil segments 16 constituting the U-phase have substantially the same configuration.

The coil segment 16U2 connecting with the coil segment 16U1 is arranged away from the coil segment 16U1 in the first circumferential direction. The coil segment 16U3 connecting with the coil segment 16U2 is arranged away from the coil segment 16U2 in the first circumferential direction. The coil segment 16U4 connecting with the coil segment 16U3 is arranged away from the coil segment 16U3 in the first circumferential direction. The coil segment 16U5 connecting with the coil segment 16U4 is arranged away from the coil segment 16U4 in the first circumferential direction. When viewed in the axial direction, the sixth extending portion A6 of the coil segment 16U5 and the first extending portion A1 of the coil segment 16U1 intersect with each other. This causes an end of the coil segment 16U5 which connects with the coil segment 16U6 to be located away from the input/output terminal 43 of the coil segment 16U1 in the first circumferential direction.

The coil segment 16U6 connecting with the coil segment 16U5 is arranged away from the coil segment 16U5 in the first circumferential direction and located circumferentially adjacent to the coil segment 16U1. The coil segments 16U7 connecting with the coil segment 16U6 is arranged away from the coil segment 16U6 in the first circumferential direction and located circumferentially adjacent to the coil segment 16U2. The coil segments 16U8 connecting with the coil segments 16U7 is arranged away from the coil segments 16U7 in the first circumferential direction and located circumferentially adjacent to the coil segment 16U3. The coil segment 16U9 connecting with the coil segments 16U8 is arranged away from the coil segments 16U8 in the first circumferential direction and located circumferentially adjacent to the coil segment 16U4. The coil segment 16U10 connecting with the coil segment 16U9 is arranged away from the coil segment 16U9 in the first circumferential direction and located circumferentially adjacent to the coil segment 16U5. An end of the coil segment 16U10 which is opposite the coil segment 16U9 serves as the neutral point 44.

The coil segment 16U11 to the coil segment 16U20 which are connected parallel to the coil segment 16U1 to the coil segment 16U10 have the same configurations as those of the coil segment 16U1 to the coil segment 16U10. The coil segment 16U11 to the coil segment 16U20 are respectively offset from the coil segment 16U1 to the coil segment 16U10 in a second circumferential direction (i.e., a clockwise direction in FIG. 6) of the coil unit 32 by 36°. This causes the vertical portions 36 of the coil segment 16U11 to the coil segment 16U20 to coincide with the vertical portions 36 of the coil segment 16U1 to the coil segment 16U10 in the circumferential direction. In the following discussion, the coil segment 16U1 to the coil segment 16U10 which are connected in series with each other will also be referred to as the conductor layer 33 or 33U. Similarly, the coil segment 16U1 to the coil segment 16U10 which are connected in series with each other will also be referred to as the conductor layer 33 or 33U. In this embodiment, each of the substrates 34 has two U-phase conductor layers 33U disposed thereon.

Although detailed descriptions with reference numerals in the drawings are omitted, the coil segments 16V1 to 16V20 constituting the V-phase have the same configurations as the coil segments 16U1 to 16U20 constituting the U-phase. The coil segments 16V1 to 16V20 of the V-phase are arranged with an offset of 12° in the second circumferential direction relative to the coil segments 16U1 to 16U20 of the U-phase. In the following discussion, the coil segments 16V1 to 16V10 connected in series will also be referred to as the conductor layer 33 or 33V, and the coil segments 16V11 to 16V20 connected in series will also be referred to as the conductor layer 33 or 33V. In the present embodiment, two conductor layers 33V for the V-phase are provided on each substrate 34. Similarly, the coil segments 16W1 to 16W20 constituting the W phase have the same configurations as the coil segments 16U1 to 16U20 constituting the U-phase. The coil segments 16W1 to 16W20 of the W-phase are arranged with an offset of 12° in the second circumferential direction relative to the coil segments 16V1 to 16V20 of the V-phase. In the following discussion, the coil segments 16W1 to 16W10 connected in series are referred to as the conductor layer 33 or 33W, and the coil segments 16W11 to 16W20 connected in series are also referred to as the conductor layer 33 or 33W. In the present embodiment, two conductor layers 33W for the W-phase are provided on each substrate 34.

The second-layer substrate 34 overlaid on the first-layer substrate 34 has the same configuration as that of the first-layer substrate 34. The coil segments 16 formed on the second-layer substrate 34 have the same configurations as those on the first-layer substrate 34. In the present embodiment, the pattern of the coil segments 16 formed on the first-layer substrate 34 coincides with that of the coil segments 16 formed on the second-layer substrate 34. The coil segments 16 on the second-layer substrate 34 are offset by 6° in the second circumferential direction from the coil segments 16 on the first-layer substrate 34. The first-layer substrate 34 and the second-layer substrate 34 are stacked on one another in the axial direction, so that the coil segments 16 on the first-layer and the second-layer substrates 34 are positioned at predetermined locations in both the circumferential and axial directions.

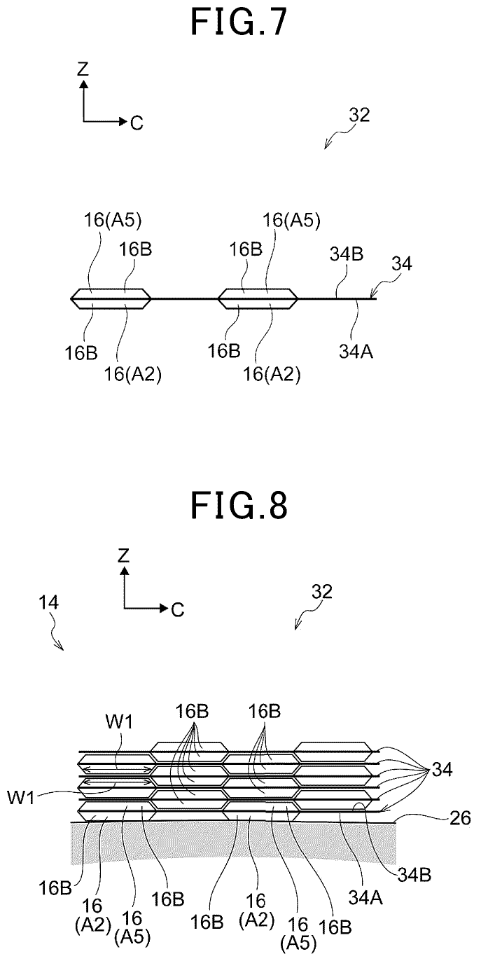

FIG. 4 schematically illustrates a state in which the first-layer substrate 34 and the second-layer substrate 34 are stacked on one another. In FIG. 4, portions of the coil segments 16 that are disposed between the first-layer substrate 34 and the second-layer substrate 34 are shown by solid lines, while the other portions of the coil segments 16 are shown by broken lines. As can be seen in FIG. 4, the portions of the coil segments 16 formed on the first-layer substrate 34 and those formed on the second-layer substrate 34 are arranged alternately in the circumferential direction and partially overlap each other in the circumferential direction of the coil unit 32. The layout of the portions of the coil segments 16 will be described in more detail later with reference to simplified FIGS. 7 and 8.

The third-layer substrate 34 and the fourth-layer substrate 34 are stacked on one another in the same manner as the first-layer substrate 34 and the second-layer substrate 34. Furthermore, even in a configuration having five or more substrates 34, the substrates 34 are stacked on one another in the same relation as that between the first-layer substrate 34 and the second-layer substrate 34. The number of substrate layers of the coil unit 32 (that is, the number of stacked substrates 34) may be appropriately determined in consideration of the required output or other specifications of the motor 10.

FIGS. 7 and 8 are sectional views showing cross sections of the coil unit 32 taken along the axial and circumferential directions, respectively. Specifically, FIG. 7 illustrates a cross section of part of one of the substrates 34 and the coil segments 16 (that is, the conductors 16B) formed on the substrate 34. FIG. 8 illustrates cross sections of the substrates 34 and the coil segments 16 (the conductors 16B) formed on the substrates 34. It should be noted that hatching is omitted in the sectional views of FIGS. 7 and 8. The following discussion refers to a first substrate that is one of the substrates 34 and a second substrate that is one of the substrates 34 which is overlaid on the first substrate in the axial direction of the coil unit 32. As can be seen in FIGS. 7 and 8, the conductors 16B on the first substate and the second substrate are arranged alternately in the circumferential direction. In addition, the conductors 16B on the first and second substrates are also partially overlapped with each other in the circumferential direction. Furthermore, as shown in FIGS. 4, 6, 7, and 8, in the axial stack of the substrates 34, the conductors 16B (i.e., the vertical portions 36) of the coil segments 16 belonging to the same phase are aligned in the axial direction.

The width W1 (i.e., a circumferential dimension) of each of the conductors 16B on the first substrate gradually decreases toward the second substrate. In other words, the width W1 of each of the conductors 16B on the second substrate decreases toward the first substrate.

### Operation and Beneficial Effects

The operation of the motor 10 and beneficial effects offered thereby will be described below.

As can be seen in FIGS. 1, 2, 4, and 5, the rotation of the rotor 12 of the motor 10 is achieved by switching electrical energization of the U-phase coil group 42U, the V-phase coil group 42V, and the W-phase coil group 42W which are part of the stator 14 to create rotating magnetic field in the stator 14.

The coil unit 32 includes the plurality of substrates 34 and the plurality of coil segments 16, which are respectively formed on the substrates 34. The substrates 34 are stacked on each other in the axial direction of the coil unit 32 so that the coil segments 16 are arranged at predetermined positions in the circumferential and axial directions of the coil unit 32. With this configuration, compared with a structure in which coils are formed by winding conductors around teeth, it is possible to suppress an increase in the axial dimension of the coil unit 32. As a result, an increase in the overall size of the motor 10 can also be suppressed.

### Structure for Minimizing Loss Caused by Circulating Current

Meanwhile, the coil unit 32, which constitutes a part of the motor 10 described above, has a configuration in which the substrates 34 of the above-described structure are laminated in the axial direction. In this configuration, distances between the plurality of coil segments 16 (that is, the conductor layers 33) respectively formed on the substrates 34 and the magnets 18 differ from one another. This results in a difference in induced voltage appearing between the coil segments 16 (i.e., the conductor layers 33) formed on one of the substrates 34 and those formed on another substrate 34, which may lead to generation of a circulating current between those substrates 34. Hereinafter, embodiments including series-connecting conductors 50 and parallel-connecting conductors 52 for suppressing losses caused by such circulating currents will be described.

### First Embodiment

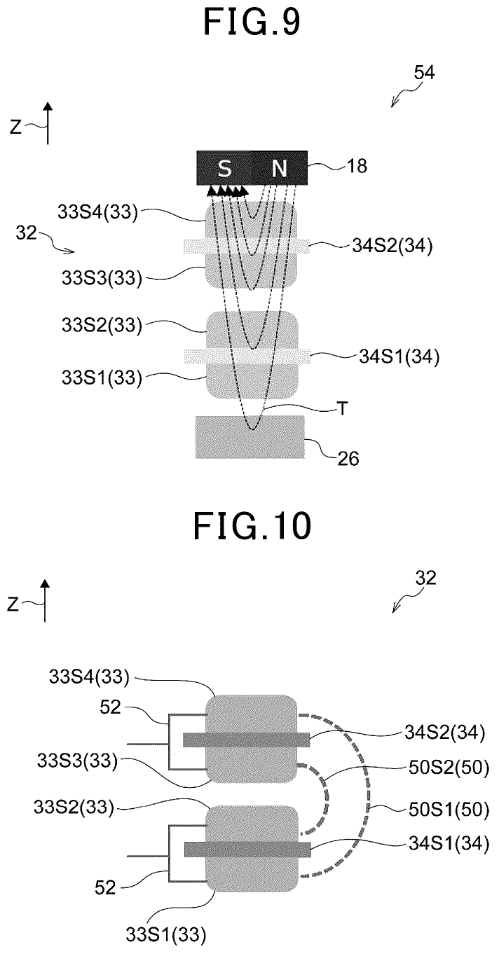

The motor 54 according to the first embodiment will be described with reference to FIGS. 9 to 11. In the first embodiment, the same members and portions of the motor 54 as those of the above-described motor 10 will be denoted by the same reference numerals, and explanation thereof in detail will be omitted where appropriate.

As shown in FIG. 9, the coil unit 32 of the motor 54 has a configuration in which two substrates 34 are stacked on one another. The substrates 34 in this embodiment includes the first substrate 34S1 and the second substrate 34S2. The first substrate 34S1 is located closer to the stator core 26, while the second substrate 34S2 is located closer to the magnets 18. It should be noted that lines indicated by reference symbol T in FIG. 9 represent the magnetic flux generated by the magnets 18.

The substrate 34S1 has two conductor layers 33 affixed thereto. FIG. 9 demonstrates one of the conductor layers 33 as being formed on a portion of one surface of the first substrate 34S1, and the other conductor layer 33 as being formed on a portion of the opposite surface of the first substrate 34S1. However, as in the case of the motor 10 described above, these conductor layers 33 are actually formed over the opposite surfaces of the substrates 34. For the sake of simplicity, FIG. 9 demonstrates the conductor layers 33 corresponding to one of the U-phase, V-phase, and W-phase. In the following discussion, one of the conductor layers 33 which is formed on one of the surfaces of the first substrate 34S1 will also be referred to as the first conductor layer 33S1, and the other conductor layer 33 will also be referred to as the second conductor layer 33S2.

The second substrate 34S2, similar to the first substrate 34S1, has two conductor layers 33 which include the third conductor layer 33S3 and the fourth conductor layer 33S4. The third conductor layer 33S3 is formed over one surface of the second substrate 34S2. The fourth conductor layer 33S4 is formed on the other surface of the second substrate 34S2.

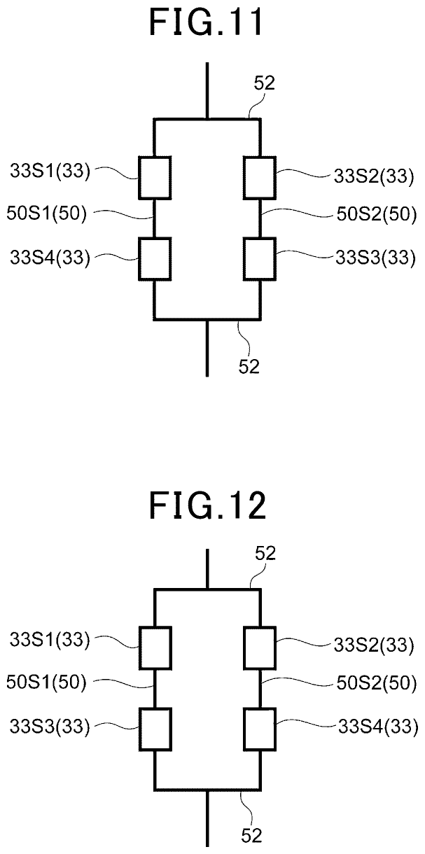

As shown in FIGS. 10 and 11, the first conductor layer 33S1 formed on the first substrate 34S1 and the fourth conductor layer 33S4 formed on the second substrate 34S2 are connected in series via the first series-connecting conductor 50S1. The second conductor layer 33S2 formed on the first substrate 34S1 and the third conductor layer 33S3 formed on the second substrate 34S2 are connected in series via the second series-connecting conductor 50S2. Furthermore, the conductor layers 33S1 and 33S4 connected by the first series-connecting conductor 50S1 are connected using the parallel-connecting conductors 52 in parallel to the conductor layers 33S2 and 33S3 connected by the second series-connecting conductor 50S2

The first base member described in the first note at the end of this specification corresponds to the first substrate 34S1. The first conductor layer formed on the first base member described in Note 1 corresponds to the first conductor layer 33S1. The second base member described in Note 1 corresponds to the second substrate 34S2. The first conductor layer formed on the second base member described in Note 1 corresponds to the fourth conductor layer 33S4. The first series-connecting conductor described in Note 1 corresponds to the first series-connecting conductor 50S1. The second conductor layer formed on the first base member described in Note 1 corresponds to the second conductor layer 3352. The second conductor layer formed on the second base member described in Note 1 corresponds to the third conductor layer 33S3. The second series-connecting conductor described in Note 1 corresponds to the second series-connecting conductor 50S2. The parallel-connecting conductors described in Note 1 correspond to the parallel-connecting conductors 52.

When the induced voltage generated in the first conductor layer 33S1 is defined as V1, the induced voltage generated in the second conductor layer 3352 is defined as V2, the induced voltage generated in the third conductor layer 33S3 is defined as V3, and the induced voltage generated in the fourth conductor layer 33S4 is defined as V4, the relationship among the induced voltages V1 to V4 in the motor 54 of this embodiment is expressed by the following Equation (1):

$$V 4 = V 3 \approx V 2 = V 1 \qquad Eq . ( 1 )$$

By connecting the fourth conductor layer 33S4 located closest to the magnets 18 and the first conductor layer 33S1 located farthest from the magnets 18 using the first series-connecting conductor 50S1 in series, and by connecting the third conductor layer 33S3 disposed closer to the magnets 18 and the second conductor layer 33S2 disposed away from the magnets 18 using the second series-connecting conductor 50S2 in series, the induced voltage appearing between the fourth conductor layer 33S4 and the first conductor layer 33S1 is made closer to the induced voltage appearing between the third conductor layer 33S3 and the second conductor layer 33S2. Furthermore, by connecting the conductor layers 33S1 and 33S4 connected by the first series-connecting conductor 50S1 and the conductor layers 33S2 and 33S3 connected by the second series-connecting conductor 50S2 in parallel via the parallel-connecting conductors 52, losses caused by circulating currents flowing between the fourth conductor layer 33S4 and the first conductor layer 33S1 and between the third conductor layer 33S3 and the second conductor layer 33S2 are suppressed. This enhances the operational efficiency and the output torque of the motor 54. It should be noted that, in a configuration in which the conductor layers 33S1, 33S2, 33S3, and 33S4 are simply connected in parallel, the relationship among the induced voltages V1 to V4 generated in the conductor layers 33S1, 33S2, 33S3, and 33S4 is expressed by the following Equation (1.1), and therefore, it is not possible to obtain the effect of suppressing losses caused by circulating currents as in the motor 54 of this embodiment.

$$V 4 > V 3 > V 2 > V 1 \qquad Eq . ( 1.1 )$$

The motor 54 may be designed to have the structure illustrated in FIG. 12. Specifically, the first conductor layer 33S1 and the third conductor layer 33S3 are connected in series via the first series-connecting conductor 50S1. The second conductor layer 33S2 and the fourth conductor layer 33S4 are connected in series via the second series-connecting conductor 50S2. The conductor layers 33S1 and 33S3 connected by the first series-connecting conductor 50S1 and the conductor layers 33S2 and 3354 connected by the second series-connecting conductor 50S2 are connected in parallel via the parallel-connecting conductors 52. This structure, similar to the motor 54 of the first embodiment, suppresses losses caused by circulating currents flowing between the conductor layers 33.

### Second Embodiment

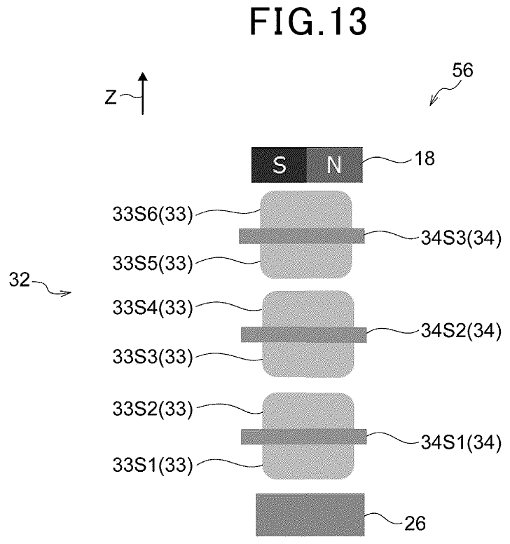

The motor 56 according to the second embodiment will be described with reference to FIGS. 13 to 15. The same components of the motor 46 as those of the above-described motor 10 or 54 are denoted by the same reference numerals, and detailed explanations thereof are omitted where appropriate.

The coil unit 32 of the motor 56, as illustrated in FIG. 13, includes three substrates 34 stacked on one another. The substrates 34 include the first substrate 34S1, the second substrate 34S2, and the third substrate 34S3, which are overlaid in this order from the stator core 26 toward the magnets 18. The first substrate 34S1 has affixed thereto two conductor layers 33 which include the first conductor layer 33S1 and the second conductor layer 3352. The first conductor layer 33S1 is formed on one surface of the first substrate 34S1, while the second conductor layer 33S2 is formed on the other surface of the first substrate 34S1. Similarly, the second substrate 34S2 has affixed thereto two conductor layers 33 which include the third conductor layer 33S3 and the fourth conductor layer 33S4. The third conductor layer 33S3 is formed on one surface of the second substrate 34S2, while the fourth conductor layer 33S4 is formed on the other surface of the second substrate 34S2. Similarly, the third substrate 34S3 has affixed thereto two conductor layers 33 which include the fifth conductor layer 33S5 and the sixth conductor layer 3356. The fifth conductor layer 33S5 is formed on one surface of the third substrate 34S3, while the sixth conductor layer 33S6 is formed on the other surface of the third substrate 34S3.

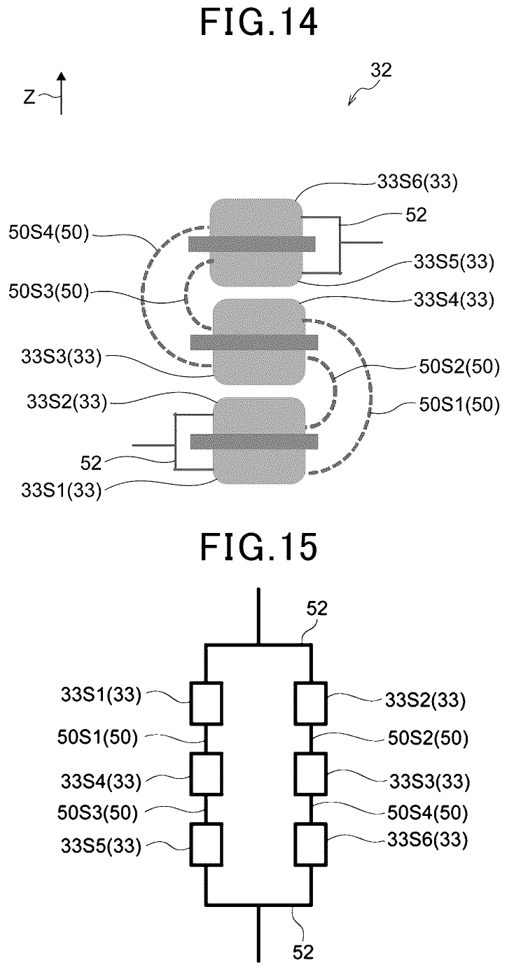

As shown in FIGS. 14 and 15, the first conductor layer 33S1 formed on the first substrate 34S1 and the fourth conductor layer 33S4 formed on the second substrate 34S2 are connected in series via the first series-connecting conductor 50S1. The second conductor layer 33S2 formed on the first substrate 34S1 and the third conductor layer 33S3 formed on the second substrate 34S2 are connected in series via the second series-connecting conductor 50S2. The fourth conductor layer 33S4 formed on the second substrate 34S2 and the fifth conductor layer 33S5 formed on the third substrate 34S3 are connected in series via the third series-connecting conductor 50S3. The third conductor layer 33S3 formed on the second substrate 34S2 and the sixth conductor layer 33S6 formed on the third substrate 34S3 are connected in series via the fourth series-connecting conductor 50S4. Furthermore, the conductor layers 33S1, 33S4, and 33S5 connected by the first and third series-connecting conductors 50S1 and 50S3, and the conductor layers 33S2, 33S3, and 33S6 connected by the second and fourth series-connecting conductors 50S2 and 50S4, are connected in parallel via the parallel-connecting conductors 52.

Note that the first base member described in appended Notes 1 and 3 corresponds to the first substrate 34S1. The second base member described in appended Notes 1 and 3 corresponds to the second substrate 34S2. The third base member described in appended Note 3 corresponds to the third substrate 34S3. The first conductor layer formed on the first base member described in appended Notes 1 and 3 corresponds to the first conductor layer 33S1. The first conductor layer formed on the second base member described in appended Notes 1 and 3 corresponds to the fifth conductor layer 33S5. The first series connection portion described in appended Notes 1 and 3 corresponds to the first series-connecting conductor 50S1 and the third series-connecting conductor 50S3. The first conductor layer formed on the third base member described in appended Note 3 corresponds to the fourth conductor layer 33S4. The second conductor layer formed on the first base member described in appended Notes 1 and 3 corresponds to the second conductor layer 33S2. The second conductor layer formed on the second base member described in appended Notes 1 and 3 corresponds to the sixth conductor layer 33S6. The second series connection portion described in appended Notes 1 and 3 corresponds to the second series-connecting conductor 50S2 and the fourth series-connecting conductor 50S4. The second conductor layer formed on the third base member described in appended Note 3 corresponds to the third conductor layer 33S3.

Here, an induced voltage generated in the first conductor layer 33S1 is defined as V1, an induced voltage generated in the second conductor layer 33S2 is defined as V2, an induced voltage generated in the third conductor layer 33S3 is defined as V3, an induced voltage generated in the fourth conductor layer 33S4 is defined as V4, an induced voltage generated in the fifth conductor layer 33S5 is defined as V5, and an induced voltage generated in the sixth conductor layer 33S6 is defined as V6. In the motor 56 of the present embodiment, the relationship among the respective induced voltages V1 to V6 is expressed by the following Equation (2):

$$V 6 = V 5 \approx V 4 = V 3 \approx V 2 = V 1 \qquad ( Eq . 2 )$$

Consequently, it is possible to bring the induced voltages generated at the conductor layers 33S1, 33S4, and 33S5, which are connected by the first series-connecting conductor 50S1 and the third series-connecting conductor 50S3, close to those generated at the conductor layers 3352, 33S3, and 33S6, which are connected by the second series-connecting conductor 5052 and the fourth series-connecting conductor 50S4. Then, by connecting the two groups of conductor layers (i.e., the conductor layers 33S1, 33S4, and 3355, and 33S2, 33S3, and 33S6 connected by the first series-connecting conductor 50S1 and the third series-connecting conductor 50S3) in parallel via the parallel-connecting conductors 52, losses due to circulating currents flowing between these groups of conductor layers can be suppressed. This enhances the efficiency in operation and output torque of the motor 56.

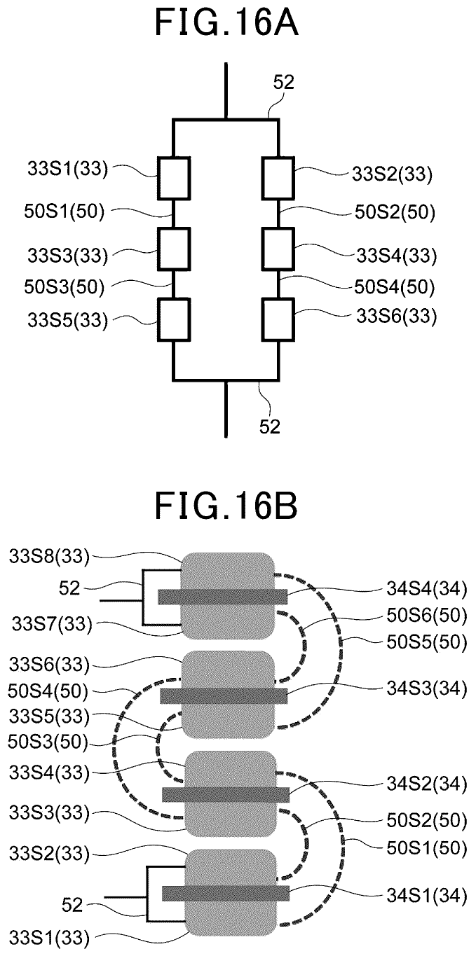

As shown in FIG. 16A, the first conductor layer 33S1 and the third conductor layer 33S3 are connected in series via the first series-connecting conductor 50S1. The second conductor layer 33S2 and the fourth conductor layer 33S4 are connected in series via the second series-connecting conductor 50S2. The third conductor layer 33S3 and the fifth conductor layer 33S5 are connected in series via the third series-connecting conductor 50S3. The fourth conductor layer 33S4 and the sixth conductor layer 3356 are connected in series via the fourth series-connecting conductor 50S4. In addition, the conductor layers 50S1, 50S3, and 50S5, which are connected by the first and third series-connecting conductors 50S1 and 50S3, respectively, are connected in parallel using the parallel-connecting conductors 52 with the conductor layers 50S2, 50S4, and 50S6, which are connected by the second and fourth series-connecting conductors 50S2 and 50S4, respectively. Even with this configuration, as in the motor 56 according to the second embodiment, losses caused by circulating currents flowing between the conductor layers 33 can be suppressed.

The coil unit 32 of the motor 56 according to the second embodiment may be designed to have a plurality of substrates 34 which are stacked on one another to form an odd number of layers (at least three layers). For example, in the coil unit 32 configured such that the plurality of the substrates 34 form five layers, the substrate 34 disposed closest to the stator core 26 corresponds to the first substrate 34S1 in the motor 56 of the second embodiment. The substrate 34 disposed closest to the magnets 18 corresponds to the third substrate 34S3 in the motor 56 of the second embodiment. Furthermore, the three substrates 34 disposed between the substrate 34 located closest to the stator core 26 and the substrate 34 located closest to the magnets 18 correspond to the second substrate 34S2 in the motor 56 of the second embodiment. The coil unit 32 of the motor 56 according to the second embodiment may, therefore, be configured to have an odd number of substrates 34, greater than or equal to five.

The coil unit 32 of the motor 56 according to the second embodiment may alternatively be designed to have a plurality of substances 34 which are stacked on one another to form an even number of layers, greater than four or more. For example, in the coil unit 32, as illustrated in FIG. 16B, configured such that the plurality of the substrates 34 form four layers, the substrate 34 disposed closest to the stator core 26 corresponds to the first substrate 34S1 in the motor 56 of the second embodiment. The substrate 34 disposed closest to the magnets 18 corresponds to the third substrate 34S3 in the motor 56 of the second embodiment. The two substrates 34 disposed between the substrate 34 located closest to the stator core 26 and the substrate 34 located closest to the magnets 18 correspond to the second substrate 34S2 in the motor 56 of the second embodiment. Specifically, the coil unit 32 has a stack of four substrates 34. The four substrates 34 include the first substrate 34S1, the second substrate 34S2, the third substrate 34S3, and the fourth substrate 34S4, which are stacked in this order from the stator core 26 toward the magnets 18. The conductor layer 33 formed on one surface of the first substrate 34S1 is referred to as the first conductor layer 33S1, while the conductor layer 33 formed on the other surface of the first substrate 34S1 is referred to as the second conductor layer 33S2. The conductor layer 33 formed on one surface of the second substrate 34S2 is referred to as the third conductor layer 3353, while the conductor layer 33 formed on the other surface of the second substrate 34S2 is referred to as the fourth conductor layer 33S4. The conductor layer 33 formed on one surface of the third substrate 34S3 is referred to as the fifth conductor layer 33S5, while the conductor layer 33 formed on the other surface of the third substrate 34S3 is referred to as the sixth conductor layer 33S6. The conductor layer 33 formed on one surface of the fourth substrate 34S4 is referred to as the seventh conductor layer 337, while the conductor layer 33 formed on the other surface of the fourth substrate 34S4 is referred to as the eighth conductor layer 33S8. The first conductor layer 33S1 formed on the first substrate 34S1 and the fourth conductor layer 33S4 formed on the second substrate 34S2 are connected in series via the first series-connecting conductor 50S1. The second conductor layer 33S2 formed on the first substrate 34S1 and the third conductor layer 33S3 formed on the second substrate 34S2 are connected in series via the second series-connecting conductor 50S2. Furthermore, the fourth conductor layer 33S4 formed on the second substrate 34S2 and the fifth conductor layer 33S5 formed on the third substrate 34S3 are connected in series via the third series-connecting conductor 50S3. The third conductor layer 33S3 formed on the second substrate 34S2 and the sixth conductor layer 3356 formed on the third substrate 34S3 are connected in series via the fourth series-connecting conductor 50S4. The fifth conductor layer 33S5 formed on the third substrate 34S3 and the eighth conductor layer 3358 formed on the fourth substrate 34S4 are connected in series via the fifth series-connecting conductor 50S5. In addition, the sixth conductor layer 33S6 formed on the third substrate 34S3 and the seventh conductor layer 33S7 formed on the fourth substrate 34S4 are connected in series via the sixth series-connecting conductor 50S6. Further, the conductor layers 33S1, 33S4, 33S5, and 33S8 connected by the first series-connecting conductor 50S1, the third series-connecting conductor 50S3, and the fifth series-connecting conductor 50S5 are connected in parallel via the parallel-connecting conductors 52 to the conductor layers 33S2, 33S3, 33S6, and 33S7 connected by the second series-connecting conductor 50S2, the fourth series-connecting conductor 50S4, and the sixth series-connecting conductor 50S6. In this manner, the coil unit 32 of the motor 56 according to the second embodiment may be designed to have a plurality of the substrates 34 are laminated to form an even number of layers, greater than or equal to four.

It should be noted that the first base member described in the appended Notes 1 and 3 at the end of this specification corresponds to the first substrate 34S1. The second base member described in the appended Notes 1 and 3 corresponds to the fourth substrate 34S4. The third base member described in the appended Note 3 corresponds to the second substrate 34S2 and the third substrate 34S3. There are a plurality of the third base members described in the appended Note 3. The first conductor layer formed on the first base member described in the appended Notes 1 and 3 corresponds to the first conductor layer 33S1. In addition, the first conductor layer formed on the second base member described in the appended Notes 1 and 3 corresponds to the eighth conductor layer 33S8. The first series-connection portion described in the appended Notes 1 and 3 corresponds to the first series-connecting conductor 50S1, the third series-connecting conductor 50S3, and the fifth series-connecting conductor 50S5. Furthermore, the first conductor layer formed on the third base member described in the appended Note 3 corresponds to the fourth conductor layer 33S4 and the fifth conductor layer 33S5. The second conductor layer formed on the first base member described in the appended Notes 1 and 3 corresponds to the second conductor layer 33S2. The second conductor layer formed on the second base member described in the appended Notes 1 and 3 corresponds to the seventh conductor layer 33S7. The second series-connection portion described in the appended Notes 1 and 3 corresponds to the second series-connecting conductor 50S2, the fourth series-connecting conductor 50S4, and the sixth series-connecting conductor 50S6. Furthermore, the second conductor layer formed on the third base member described in the appended Note 3 corresponds to the third conductor layer 33S3 and the sixth conductor layer 33S6.

### Third Embodiment

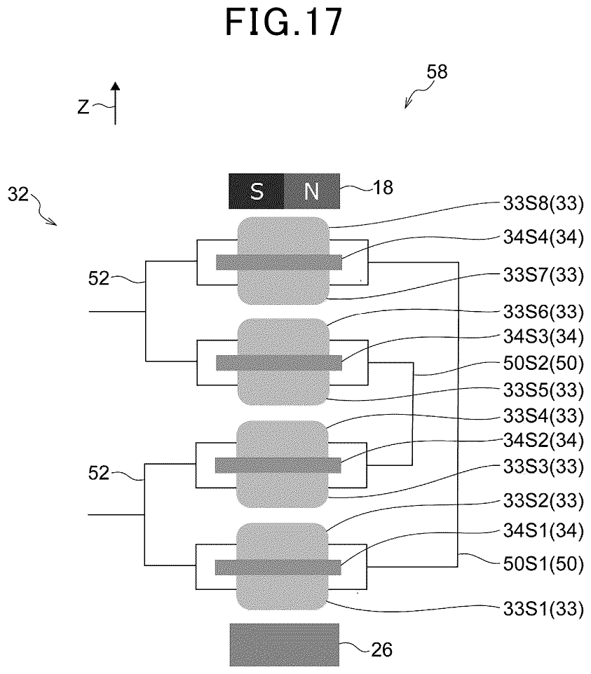

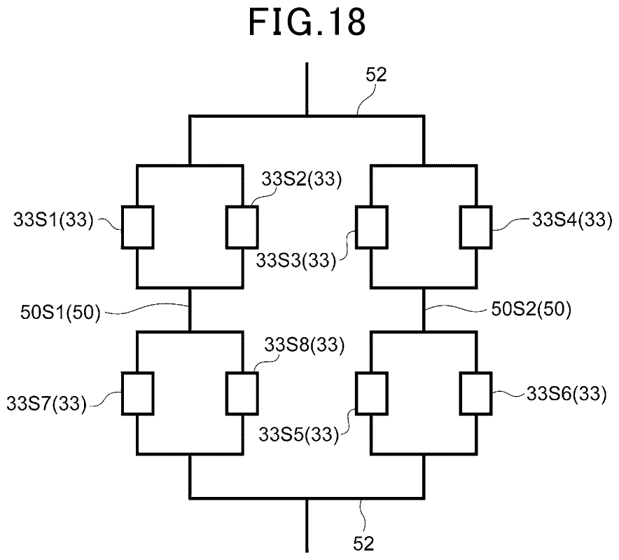

The motor 58 of the third embodiment will now be described with reference to FIGS. 17 and 18. It should be noted that the same members or portions of the motor 58 as those of the motor 10 or 54 in the above embodiments are denoted by the same reference numerals, and explanation thereof in detail will be omitted here.

The coil unit 32 of the motor 58 in this embodiment, as illustrated in FIG. 17, includes a stack of four substrates 34 which include the first substrate 34S1, the second substrate 34S2, the third substrate 34S3, and the fourth substrate 34S4, which are stacked on one another in this order from the stator core 26 toward the magnets 18. The conductor layer 33 formed on one surface of the first substrate 34S1 is referred to as the first conductor layer 33S1, while the conductor layer 33 formed on the other surface of the first substrate 34S1 is referred to as the second conductor layer 33S2. The conductor layer 33 formed on one surface of the second substrate 34S2 is referred to as the third conductor layer 33S3, while the conductor layer 33 formed on the other surface of the second substrate 34S2 is referred to as the fourth conductor layer 33S4. The conductor layer 33 formed on one surface of the third substrate 34S3 is referred to as the fifth conductor layer 33S5, while the conductor layer 33 formed on the other surface of the third substrate 34S3 is referred to as the sixth conductor layer 3356. The conductor layer 33 formed on one surface of the fourth substrate 34S4 is referred to as the seventh conductor layer 33S7, while the conductor layer 33 formed on the other surface of the fourth substrate 34S4 is referred to as the eighth conductor layer 3358.

As shown in FIGS. 17 and 18, the first conductor layer 33S1 and the second conductor layer 33S2, which are formed on the first substrate 34S1, are connected in parallel. Similarly, the third conductor layer 33S3 and the fourth conductor layer 3354, which are formed on the second substrate 34S2, are connected in parallel. Furthermore, the fifth conductor layer 33S5 and the sixth conductor layer 33S6, which are formed on the third substrate 34S3, are connected in parallel. Likewise, the seventh conductor layer 33S7 and the eighth conductor layer 33S8, which are formed on the fourth substrate 34S4, are connected in parallel.

The first conductor layer 3351 and the second conductor layer 33S2 formed on the first substrate 34S1 are connected in series, via the first series-connecting conductor 50S1, to the seventh conductor layer 33S7 and the eighth conductor layer 33S8 formed on the fourth substrate 34S4. The third conductor layer 33S3 and the fourth conductor layer 33S4 formed on the second substrate 34S2 are connected in series, via the second series-connecting conductor 50S2, to the fifth conductor layer 33S5 and the sixth conductor layer 33S6 formed on the third substrate 34S3. Moreover, the conductor layers 33S1, 33S2, 3357, and 33S8 connected by the first series-connecting conductor 50S1 are connected in parallel, via the parallel-connecting conductors 52, to the conductor layers 33S3, 33S4, 33S5, and 33S6 connected by the second series-connecting conductor 50S2.

It should be noted that the first base member described in appended Note 2 at the end of this specification corresponds to the first substrate 34S1. The plurality of conductor layers formed on the first base member and connected in parallel to each other, as described in appended Note 2, correspond to the first conductor layer 33S1 and the second conductor layer 33S2. The second base member described in appended Note 2 corresponds to the fourth substrate 34S4. The plurality of conductor layers formed on the second base member and connected in parallel to each other, as described in appended Note 2, correspond to the seventh conductor layer 33S7 and the eighth conductor layer 33S8. The first series-connection portion described in appended Note 2 corresponds to the first series-connecting conductor 50S1. Furthermore, the third base member described in appended Note 2 corresponds to the second substrate 34S2. The plurality of conductor layers formed on the third base member and connected in parallel to each other, as described in appended Note 2, correspond to the third conductor layer 33S3 and the fourth conductor layer 33S4. The fourth base member described in appended Note 2 corresponds to the third substrate 34S3. The plurality of conductor layers formed on the fourth base member and connected in parallel to each other, as described in appended Note 2, correspond to the fifth conductor layer 33S5 and the sixth conductor layer 33S6. The second series-connecting conductor described in appended Note 2 corresponds to the second series-connecting conductor 50S2. The parallel-connecting conductor described in appended Note 2 corresponds to the parallel-connecting conductors 52.

Here, the induced voltage generated in the first conductor layer 33S1 is defined as V1. The induced voltage generated in the second conductor layer 33S2 is defined as V2. The induced voltage generated in the third conductor layer 33S3 is defined as V3. The induced voltage generated in the fourth conductor layer 33S4 is defined as V4. The induced voltage generated in the fifth conductor layer 33S5 is defined as V5. The induced voltage generated in the sixth conductor layer 33S6 is defined as V6. The induced voltage generated in the seventh conductor layer 33S7 is defined as V7. The induced voltage generated in the eighth conductor layer 33S8 is defined as V8. In the motor 58 according to the present embodiment, the relationship among the induced voltages V1 to V8 satisfies the following Equation (3).

$$V 8 = V 7 \approx V 6 = V 5 \approx V 4 = V 3 \approx V 2 = V 1 \qquad Eq . ( 3 )$$

Consequently, it is possible to bring the induced voltages developed at the conductor layers 33S1, 3352, 33S7, and 33S8 connected by the first series-connecting conductor 50S1 close to the induced voltages generated at the conductor layers 33S3, 33S4, 33S5, and 33S6 connected by the second series-connecting conductor 50S2. Then, by connecting the conductor layers 33S1, 33S2, 33S7, and 33S8 connected by the first series-connecting conductor 50S1 in parallel with the conductor layers 33S3, 33S4, 3355, and 33S6 connected by the second series-connecting conductor 50S2 via the parallel-connecting conductors 52, losses caused by circulating currents flowing between these conductor layers can be suppressed. This enhances the efficiency in operation and output torque of the motor 58.

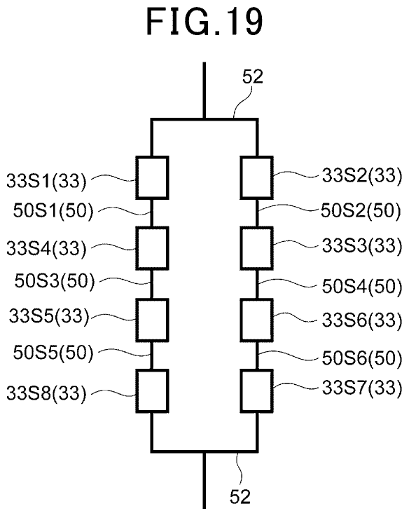

As shown in FIG. 19, the first conductor layer 33S1 and the fourth conductor layer 334 are connected in series via the first series-connecting conductor 50S1. The second conductor layer 33S2 and the third conductor layer 33S3 are connected in series via the second series-connecting conductor 50S2. The fourth conductor layer 33S4 and the fifth conductor layer 33S5 are connected in series via the third series-connecting conductor 50S3. The third conductor layer 33S3 and the sixth conductor layer 33S6 are connected in series via the fourth series-connecting conductor 50S4. The fifth conductor layer 33S5 and the eighth conductor layer 33S8 are connected in series via the fifth series-connecting conductor 50S5. The sixth conductor layer 33S6 and the seventh conductor layer 33S7 are connected in series via the sixth series-connecting conductor 50S6. In addition, the conductor layers 33S1, 33S4, 33S5, and 33S8, which are connected by the first, third, and fifth series-connecting conductors 50S1, 50S3, and 50S5, respectively, are connected in parallel via the parallel-connecting conductors 52 with the conductor layers 33S2, 33S3, 33S6, and 33S7, which are connected by the second, fourth, and sixth series-connecting conductors 50S2, 50S4, and 50S6, respectively. Even in this configuration, as with the motor 58 of the third embodiment described above, losses due to circulating currents flowing between the respective conductor layers 33 can be suppressed.

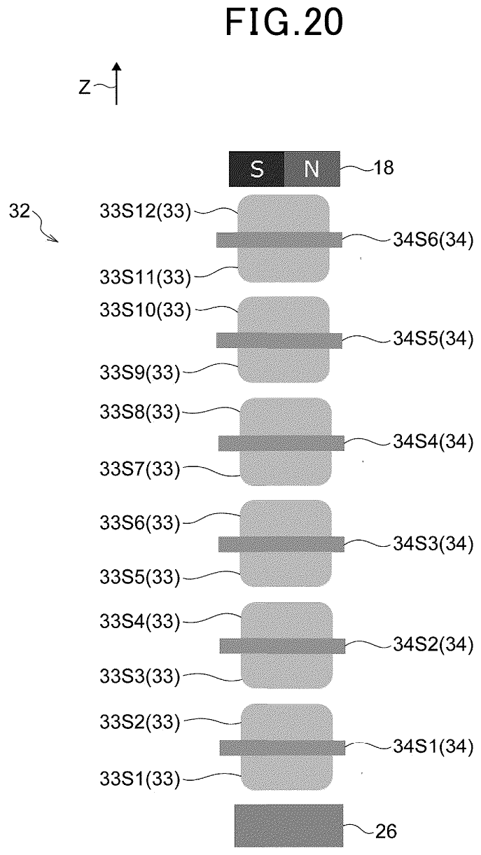

The coil unit 32 of the motor 58 in the third embodiment may alternatively be designed to have an even number of substrates 34, which are stacked into four or more layers. For instance, the substrates 34 are stacked on one another into six layers. One of the substrates 34 located closest to the stator core 26 corresponds to the first substrate 34S1 of the motor 58 in the third embodiment. One of the substrates 34 located closest to the magnets 18 corresponds to the fourth substrate 34S4 of the motor 58 in the third embodiment. The remaining four substrates 34 between the outermost substrates 34 located closest to the stator core 26 and the magnets 18 correspond to the second substrate 34S2 and the third substrate 34S3 of the motor 58 in the third embodiment. As apparent from the above discussion, the coil unit 32 of the motor 58 in the third embodiment may be designed to have an even number of substrates 34 stacked on one another into six or more layers. Specifically, the coil unit 32 may be designed to have the structure illustrated in FIG. 20, which includes six substrates 34 stacked on one another. The substrates 34 include the first substrate 34S1, the second substrate 34S2, the third substrate 34S3, the fourth substrate 34S4, the fifth substrate 34S5, and the sixth substrate 34S6 which are stacked in this order from the stator core 26 toward the magnets 18. One of the conductor layers 33 formed on one surface of the first substrate 34S1 is referred to as the first conductor layer 33S1, while the other is referred to as the second conductor layer 3352. One of the conductor layers 33 formed on one surface of the second substrate 34S2 is referred to as the third conductor layer 33S3, while the other is referred to as the fourth conductor layer 334. One of the conductor layers 33 formed on one surface of the third substrate 34S3 is referred to as the fifth conductor layer 33S5, while the other is referred to as the sixth conductor layer 33S6. One of the conductor layers 33 formed on one surface of the fourth substrate 34S4 is referred to as the seventh conductor layer 33S7, while the other is referred to as the eighth conductor layer 33S8. One of the conductor layers 33 formed on one surface of the fifth substrate 34S5 is referred to as the ninth conductor layer 339, while the other is referred to as the tenth conductor layer 33S10. One of the conductor layers 33 formed on one surface of the sixth substrate 34S6 is referred to as the eleventh conductor layer 33S11, while the other is referred to as the twelfth conductor layer 33S12.

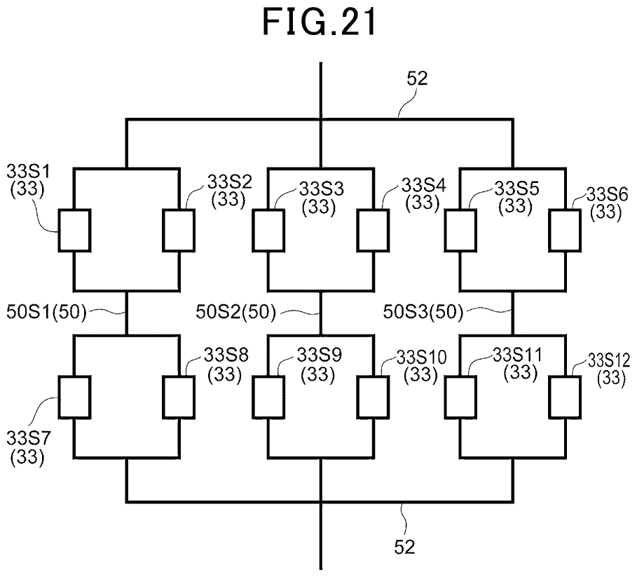

As shown in FIG. 21, the first conductor layer 33S1 and the second conductor layer 3352 formed on the first substrate 34S1 are connected in parallel. The third conductor layer 33S3 and the fourth conductor layer 33S4 formed on the second substrate 34S2 are connected in parallel. The fifth conductor layer 33S5 and the sixth conductor layer 33S6 formed on the third substrate 34S3 are connected in parallel. The seventh conductor layer 33S7 and the eighth conductor layer 3358 formed on the fourth substrate 34S4 are connected in parallel. The ninth conductor layer 33S9 and the tenth conductor layer 33S10 formed on the fifth substrate 34S5 are connected in parallel. The eleventh conductor layer 33S11 and the twelfth conductor layer 33S12 formed on the sixth substrate 34S6 are connected in parallel.

In addition, the first conductor layer 33S1 and the second conductor layer 33S2 formed on the first substrate 34S1 are connected in series using the first series-connecting conductor 50S1 with the seventh conductor layer 33S7 and the eighth conductor layer 33S8 formed on the fourth substrate 34S4. The third conductor layer 33S3 and the fourth conductor layer 3354 formed on the second substrate 34S2 are connected in series using the second series-connecting conductor 50S2 with and the ninth the conductor layer 3359 and the tenth the conductor layer 33S10 formed on the fifth substrate 34S5. The fifth conductor layer 33S5 and the sixth conductor layer 33S6 formed on the third substrate 34S3 are connected in series using the third series-connecting conductor 50S3 with and the eleventh the conductor layer 33S11 and the twelfth the conductor layer 33S12 formed on the sixth substrate 34S6. Furthermore, the conductor layers 33S1, 33S2, 3357, and 3358 connected by the first series-connecting conductor 50S1, the conductor layers 33S3, 33S4, 33S9, and 33S10 connected by the second series-connecting conductor 50S2, and the conductor layers 33S5, 33S6, 33S11, and 33S12 connected by the third series-connecting conductor 50S3 are electrically connected in parallel using the parallel-connecting conductors 52. Even in this configuration, as in the motor 58 of the above-described third embodiment, it is possible to suppress losses due to circulating currents flowing between the respective the conductor layers 33.

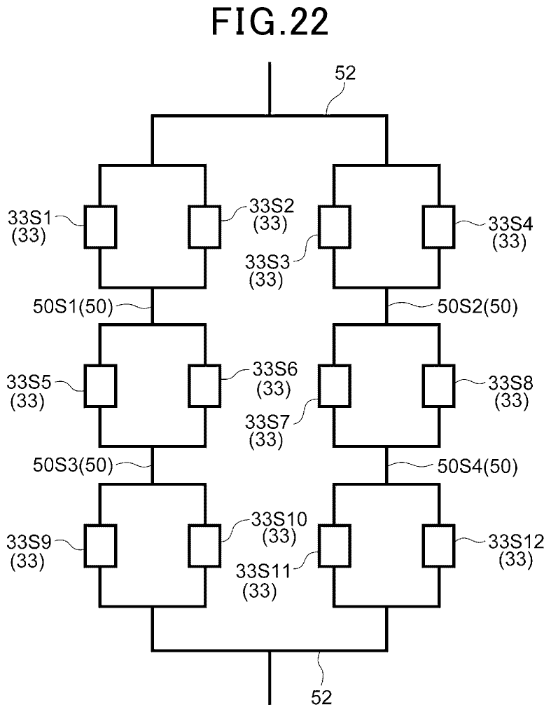

The coil unit 32 having a stack of six substrates 34 may alternatively be designed to have a structure illustrated in FIG. 22. Specifically, the first conductor layer 33S1 and the second conductor layer 33S2 formed on the first substrate 34S1 are connected in series using the first series-connecting conductor 50S1 with the fifth conductor layer 33S5 and the sixth conductor layer 33S6 formed on the third substrate 34S3. The third conductor layer 33S3 and the fourth conductor layer 33S4 formed on the second substrate 34S2 are connected in series using the second series-connecting conductor 50S2 with the seventh conductor layer 33S7 and the eighth conductor layer 33S8 formed on the fourth substrate 34S4. The fifth conductor layer 33S5 and the sixth conductor layer 33S6 formed on the third substrate 34S3 are connected in series using the third series-connecting conductor 50S3 with the ninth conductor layer 3359 and the tenth conductor layer 33S10 formed on the fifth substate 34S5. The seventh conductor layer 3357 and the eighth conductor layer 33S8 formed on the fourth substrate 34S4 are connected in series using the fourth series-connecting conductor 50S4 with the eleventh conductor layer 33S11 and the twelfth conductor layer 33S12 formed on the sixth substrate 34S6. In addition, the conductor layers 33S1, 33S2, 33S5, 33S6, 33S9, and 33S10 connected by the first series-connecting conductor 50S1 and the third series-connecting conductor 50S3 are connected in parallel, via the parallel-connecting conductors 52, with the conductor layers 33S3, 33S4, 3367, 3358, 33S11, and 33S12 connected by the second series-connecting conductor 50S2 and the fourth series-connecting conductor 50S4. Even in this configuration, as in the motor 58 of the above-described third embodiment, losses due to circulating currents flowing between the respective conductor layers 33 can be suppressed. It is to be noted that the structure shown in FIG. 22 is a modification of the coil unit 32 illustrated in FIGS. 17 and 18, in which six substrates 34 are stacked to form six layers.

### Fourth Embodiment

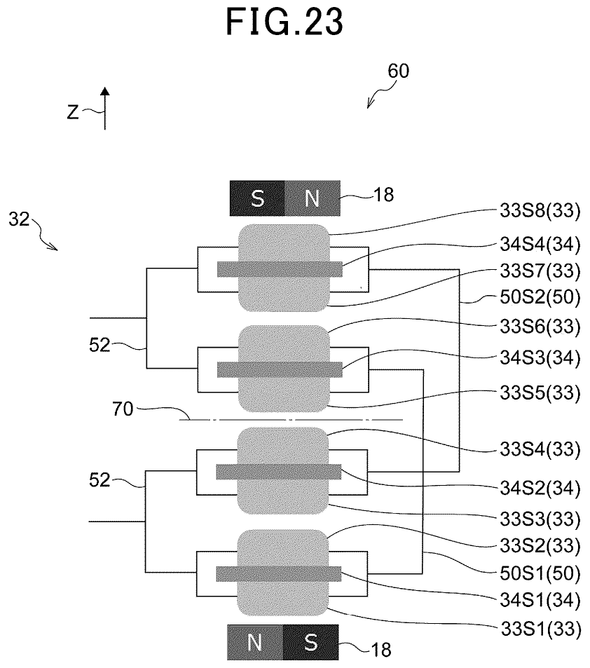

A description of the motor 60 according to the fourth embodiment will now be given with reference to FIG. 23. It should be noted that the same parts of the motor 60 as those of the motor 10 or 54 in the above-described embodiments are denoted by the same reference numerals, and explanation thereof in detail will be omitted here.

The motor 60 in this embodiment includes the coil unit 32, as can be seen in FIG. 23, equipped with two sets of magnets 18 (which will also be referred to below as a first set and a second set of magnets 18) disposed on axially-opposed sides of the coil unit 32 (which will also be referred to below as a first axial side and a second axial side). This type of motor is usually referred to as a double-axial motor. The coil unit 32 of the motor 60 includes a stack of four substrates 34, namely the first substrate 34S1, the second substrate 34S2, the third substrate 34S3, and the fourth substrate 34S4 which are stacked on one another in this order from the first set of magnets 18 toward the second set of magnets 18. The stack of the substrates 34 has the center portion 70 (which will also be referred to below as a center position) in the axial direction of the motor 60. The center portion 70 is located between the second substrate 34S2 and the third substrate 34S3 and divides the first and second axial sides.

The first conductor layer 33S1 and the second conductor layer 33S2 formed on the first substrate 34S1 are connected in series using the first series-connecting conductor 50S1 with the fifth conductor layer 33S5 and the sixth conductor layer 33S6 formed on the third substrate 34S3. The third conductor layer 33S3 and the fourth conductor layer 33S4 formed on the second substrate 34S2 are connected in series using the second series-connecting conductor 50S2 with the seventh conductor layer 33S7 and the eighth conductor layer 33S8 formed on the fourth substrate 34S4. This arrangement enables the induced voltages generated at the conductor layers 33S1, 33S2, 33S5, and 33S6, which are connected together using the first series-connecting conductor 50S1, to be made close to those at the conductor layers 33S3, 33S4, 33S7, and 33S8, which are connected together using the second series-connecting conductor 50S2. The conductor layers 33S1, 33S2, 33S5, and 33S6 connected by the first series-connecting conductor 50S1 are connected in parallel using the parallel-connecting conductors 52 to the conductor layers 33S3, 33S4, 33S7, and 33S8 connected by the second series-connecting conductor 50S2, thereby suppressing losses caused by circulating currents flowing between the respective the conductor layers 33S1, 33S2, 33S5, and 33S6 and the respective the conductor layers 33S3, 33S4, 3357, and 33S8. This enhances the efficiency in operation and output torque of the motor 60, It should be noted that the configuration of the present embodiment is effective for a double-axial motor.

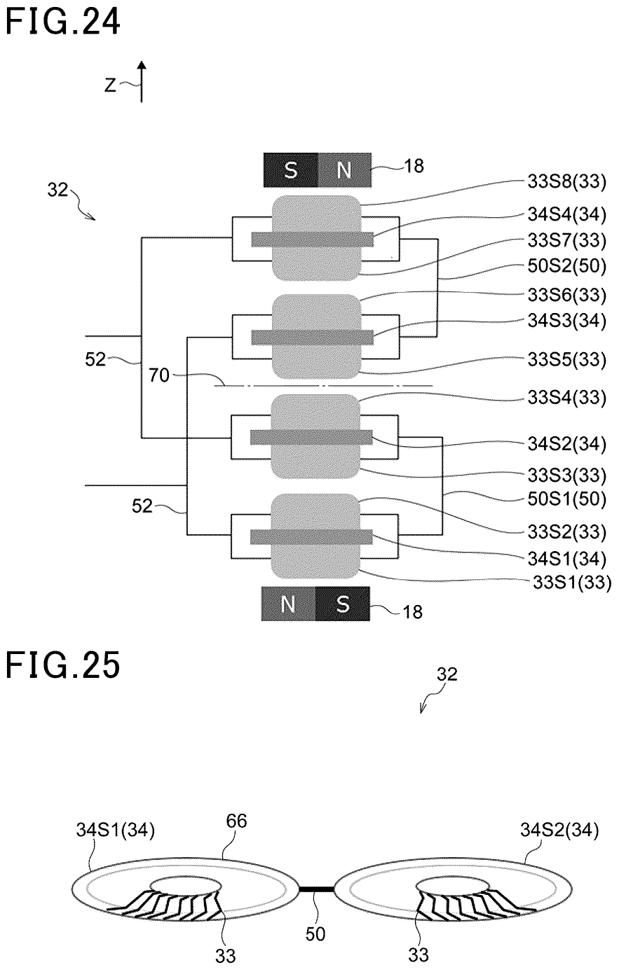

The coil unit 32 may alternatively be designed to have the structure illustrated in FIG. 24. Specifically, the first conductor layer 33S1 and the second conductor layer 3352 formed on the first substrate 34S1, and the third conductor layer 33S3 and the fourth conductor layer 33S4 formed on the second substrate 34S2, are connected in series via the first series-connecting conductor 50S1. The fifth conductor layer 33S5 and the sixth conductor layer 33S6 formed on the third substrate 34S3, and the seventh conductor layer 33S7 and the eighth conductor layer 33S8 formed on the fourth substrate 34S4, are connected in series via the second series-connecting conductor 50S2. In addition, the conductor layers 33S1, 33S2, 33S3, and 33S4 connected by the first series-connecting conductor 50S1 are connected in parallel, via the parallel-connecting conductors 52, with the conductor layers 3355, 33S6, 33S7, and 3358 connected by the second series-connecting conductor 50S2. Even with this configuration, as in the motor 60 of the fourth embodiment described above, losses due to circulating currents flowing between the conductor layers 33 can be suppressed.

### Fifth Embodiment

A description will now be given of the motor of the fifth embodiment with reference to FIGS. 25 to 27. It is to be noted that the same parts of the motor of the fifth embodiment as those of the motor 10 or 54 in the above-described embodiments are denoted by the same reference numerals, and explanation thereof in detail will be omitted here.

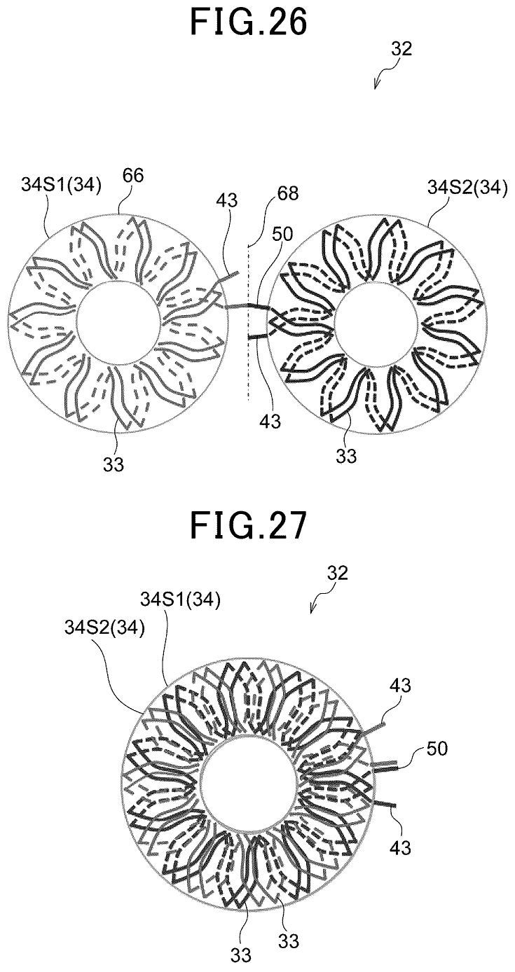

As shown in FIGS. 25 to 27, the coil unit 32 in this embodiment includes the first substrate 34S1 and the second substrate 34S2 which are connected to each other via the interlayer connector 64, which will be described in detail later. More specifically, the first substrate 34S1 and the second substrate 34S2 are made of the single planar member 66. The conductor layers 33 are formed on the first substrate 34S1 and the second substrate 34S2 of the planar member 66. The planar member 66 also has the series-connecting conductor 50 formed between the first substrate 34S1 and the second substrate 34S2. The series-connecting conductor 50 electrically connects the conductor layers 33 formed on the first substrate 34S1 and the second substrate 34S2. The planar member 66 is, as can be seen in FIGS. 26 and 27, folded back at the fold-back position 68 so that the first substrate 34S1 and the second substrate 34S2 are laminated on one another. The configuration of the present embodiment enables the conductor layers 33, which are to be arranged on the first substrate 34S1 and the second substrate 34S2, to be formed on the single planar member 66, and also eliminates the need for an additional step of connecting the conductor layer 33 on the first substrate 34S1 with the conductor layer 33 on the second substrate 34S2 using the series-connecting conductor 50.

### Sixth Embodiment

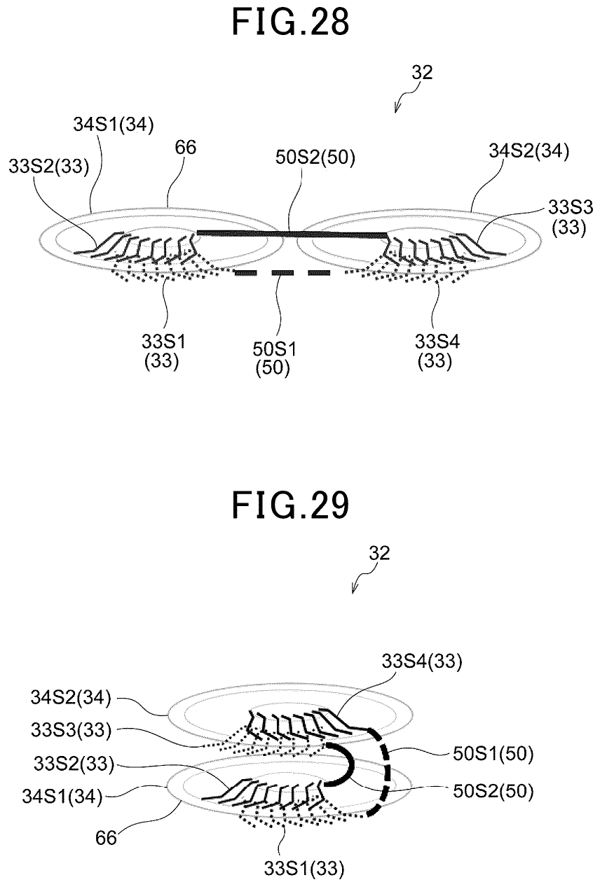

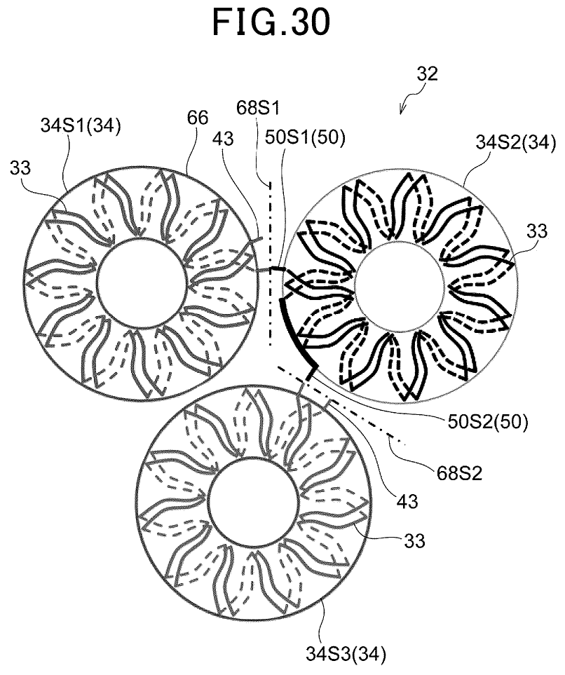

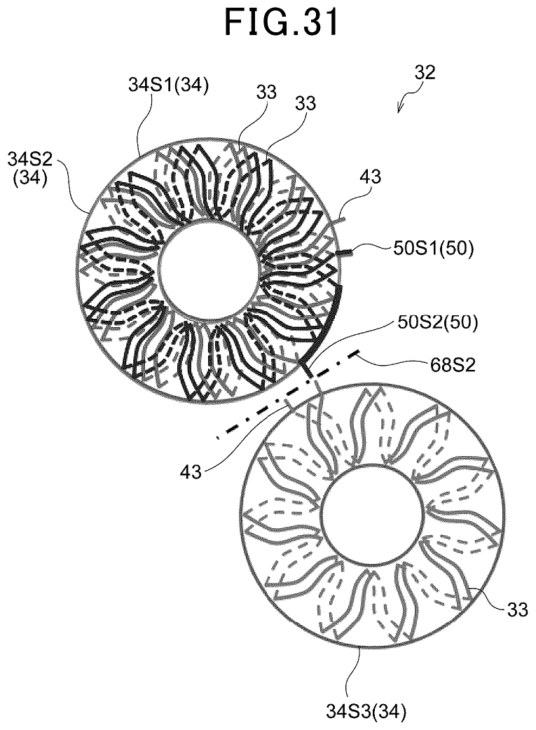

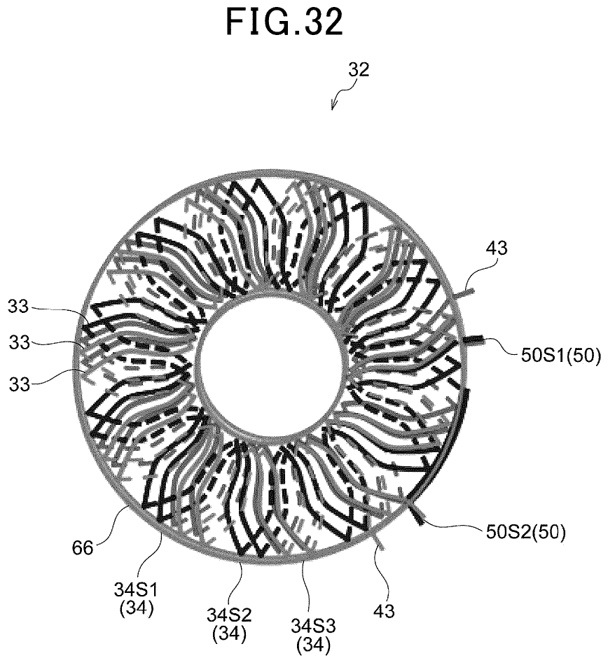

The motor according to the sixth embodiment will be described below with reference to FIGS. 28 to 29. The same reference numbers as those used for the motor 10 or 54 in the above-described embodiments will refer to the same parts, and explanation thereof in detail will be omitted here.

The motor of the present embodiment, as illustrated in FIGS. 28 and 29, has the coil unit 32 which is configured such that, similarly to the coil unit 32 of the fifth embodiment, the first substrate 34S1 and the second substrate 34S2 are formed by the single planar member 66. The planar member 66 has formed thereon the first series-connecting conductor 50S1 and the second series-connecting conductor 50S2 which extend cover the first substrate 34S1 and the second substrate 34S2. The first series-connecting conductor 50S1 connects the first conductor layer 33S1 and the fourth conductor layer 33S4 in series with each other, which are formed on the first substrate 34S1 and the second substrate 34S2, respectively. The second series-connecting conductor 50S2 connects the second conductor layer 33S2 and the third conductor layer 33S3 in series with each other, which are formed on the first substrate 34S1 and the second substrate 34S2, respectively. The conductor layers 33 are formed on the first substrate 34S1 and the second substrate 34S2 of the single planar member 66. The configuration of the present embodiment eliminates the need for additional manufacturing steps for connecting the first conductor layer 33S1 formed on the first substrate 34S1 and the fourth conductor layer 33S4 formed on the second substrate 34S2 via the first series-connecting conductor 50S1, as well as additional manufacturing steps for connecting the second conductor layer 33S2 formed on the first substrate 34S1 and the third conductor layer 33S3 formed on the second substrate 34S2 via the second series-connecting conductor 50S2.

### Seventh Embodiment

The motor according to the seventh embodiment will be described with reference to FIGS. 30 to 32. The same components or parts of the motor in this embodiment as those of the motor 10 or 54 of the foregoing embodiments are denoted by the same reference numerals, and explanation thereof in detail will be omitted here.

The coil unit 32 of the motor in this embodiment, as illustrated in FIGS. 30 to 32, includes the first substrate 34S1, the second substrate 34S2, and the third substrate 34S3, which are connected to one another via the interlayer connector 64, which will be described in detail later. More specifically, as shown in FIG. 30, the first substrate 34S1, the second substrate 34S2, and the third substrate 34S3 are formed from the single planar member 66. The conductor layers 33 are respectively provided on portions of the planar member 66 which define the first substrate 34S1, the second substrate 34S2, and the third substrate 34S3. The planar member 66 has formed thereon the first series-connecting conductor 50S1 which extends over the first substrate 34S1 and the second substrate 34S2 and connects the conductor layers 33 formed on the first substrate 34S1 in series with the conductor layers 33 formed on the second substrate 34S2. In addition, the planar member 66 has also formed thereon the second series-connecting conductor 50S2 which extends over the second substrate 34S2 and the third substrate 34S3 and connects the conductor layer 33 formed on the second substrate 34S2 in series with the conductor layer 33 formed on the third substrate 34S3. The planar member 66 is, as demonstrated in FIGS. 30 and 31, folded back at the first fold-back position 68S1, thereby stacking the first substrate 34S1 and the second substrate 34S2 on one another. In addition, the planar member 66 is, as demonstrated in FIGS. 31 and 32, folded back at the second fold-back position 68S2, thereby stacking the second substrate 34S2 and the third substrate 34S3 on one another. This creates a stack of the first substrate 34S1, the second substrate 34S2, and the third substrate 34S3. As apparent from the above discussion, the configuration in this embodiment produces the conductor layers 33 on areas of the single planar member 66 which define the first substrate 34S1, the second substrate 34S2, and the third substrate 34S3. The configuration of the present embodiment eliminates the need for additional manufacturing steps for connecting the conductor layer 33 formed on the first substrate 34S1 and the conductor layer 33 formed on the second substrate 34S2 via the first series-connecting conductor 50S1, as well as additional manufacturing steps for connecting the conductor layer 33 formed on the second substrate 34S2 and the conductor layer 33 formed on the third substrate 34S3 via the second series-connecting conductor 50S2.

### Eighth Embodiment

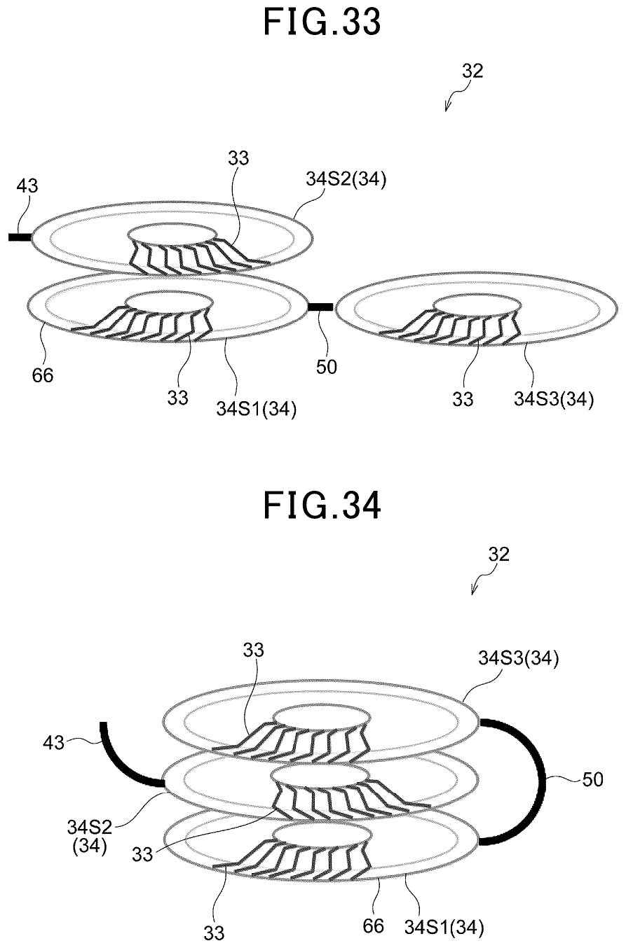

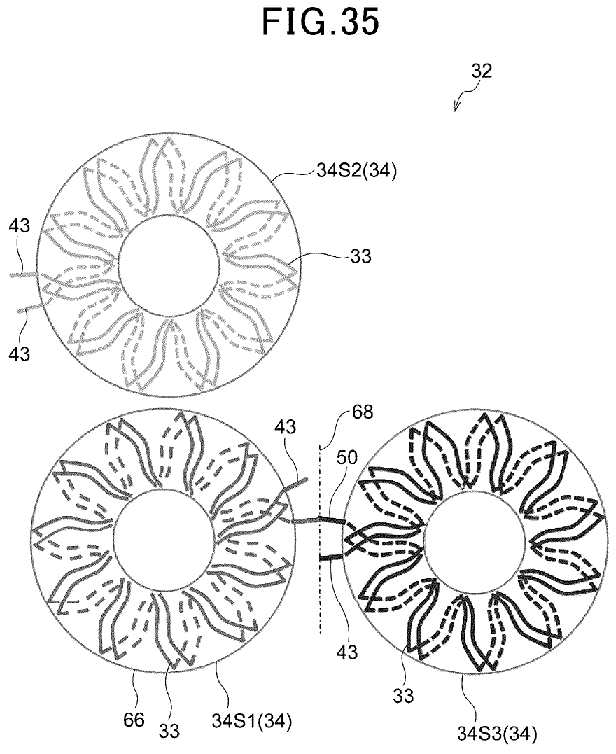

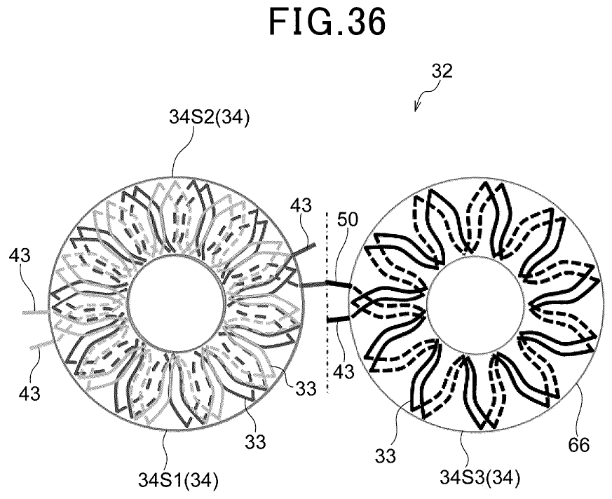

The motor according to the eighth embodiment will be described with reference to FIGS. 33 to 37. The same components or parts of the motor in this embodiment as those of the motor 10 or 54 of the foregoing embodiments are denoted by the same reference numerals, and explanation thereof in detail will be omitted here.

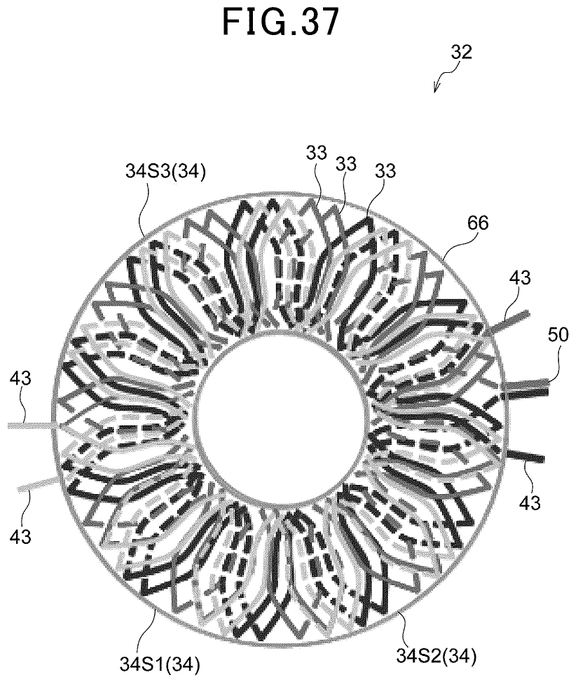

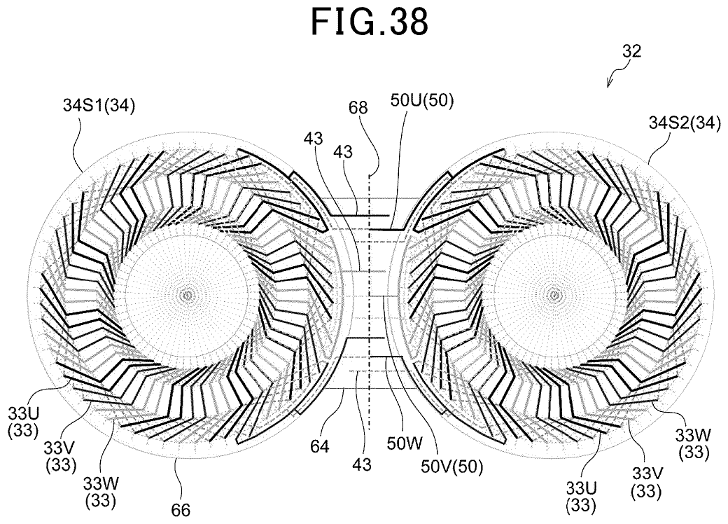

The coil unit 32 of the motor in this embodiment, as illustrated in FIGS. 33 and 34, includes the first substrate 34S1 and the third substrate 34S3 which are connected to each other via the interlayer connector 64, which will be described in detail later. More specifically, as shown in FIG. 33, the first substrate 34S1 and the third substrate 34S3 are formed from the single planar member 66. The conductor layers 33 are respectively formed on areas of the planar member 66 which define the first substrate 34S1 and the third substrate 34S3. In addition, the planar member 66 has formed thereon the series-connecting conductor 50 which extends over the first substrate 34S1 and the third substrate 34S3 and connects, in series, the conductor layer 33 on the first substrate 34S1 with the conductor layer 33 on the third substrate 34S3. Then, as shown in FIGS. 34 to 36, by folding back the planar member 66 at the fold-back position 68, the first substrate 34S1 and the third substrate 34S3 are stacked. Before the planar member 66 is folded back completely at the fold-back position 68, the second substrate 34S2 is placed between the first substrate 34S1 and the third substrate 34S3. The above manner, as shown in FIGS. 34 and 37, creates a stack of the first substrate 34S1, the second substrate 34S2, and the third substrate 34S3. The configuration of this embodiment is capable of forming the conductor layers 33 respectively on the first substrate 34S1 and the third substrate 34S3 using the single planar member 66. In addition, the configuration of this embodiment eliminates the need for an additional manufacturing step of connecting the conductor layers 33 formed on the first substrate 34S1 and the third substrate 34S3 using the series-connecting conductor 50.

### Ninth Embodiment

The motor according to the ninth embodiment will be described with reference to FIG. 38. The same components or parts of the motor in this embodiment as those of the motor 10 or 54 of the foregoing embodiments are denoted by the same reference numerals, and explanation thereof in detail will be omitted here.

As shown in FIG. 38, the coil unit 32 of the motor in this embodiment includes the first substrate 34S1 and the second substrate 34S2 which are connected to each other the interlayer connector 64. The first substrate 34S1 and the second substrate 34S2 in this embodiment correspond, for example, to the second substrate 34S2 and the third substrate 34S3, and to the first substrate 34S1 and the fourth substrate 34S4, respectively, of the coil unit 32 of the motor 58 according to the third embodiment described above. More specifically, the first substrate 34S1 and the second substrate 34S2 are formed from the single planar member 66. The planar member 66 has the U-phase conductor layers 33U, the V-phase conductor layers 33V, and the W-phase conductor layers 33W, which are respectively formed on areas of the planar member 66 which define the first substrate 34S1 and the second substrate 34S2. On the interlayer connector 64 connecting the first substrate 34S1 and the second substrate 34S2 on the planar member 66, the U-phase series-connecting conductor 50U is formed to connect, in series, the U-phase conductor layers 33U on the first substrate 34S1 to the U-phase conductor layers 33U on the second substrate 34S2. The interlayer connector 64 also has formed thereon the V-phase series-connecting conductor 50V which connects, in series, the V-phase conductor layer 33V on the first substrate 34S1 to the V-phase conductor layer 33V on the second substrate 34S2. Furthermore, the interlayer connector 64 also has formed thereon the W-phase series-connecting conductor 50W which connects, in series, the W-phase conductor layer 33W on the first substrate 34S1 to the W-phase conductor layer 33W on the second substrate 34S2. Further, the interlayer connector 64 also has formed thereon the input/output conductors 43 each of which serves as a current input path to each of the conductor layers 33 or a current output path from each of the conductor layers 33. The U-phase series-connecting conductor 50U, the V-phase series-connecting conductor 50V, and the W-phase series-connecting conductor 50W correspond, for example, to the first series-connecting conductor 50S1 and the second series-connecting conductor 50S2 of the coil unit 32 of the motor 58 according to the third embodiment described above. Then, by folding back the planar member 66 at the fold-back position 68 of the interlayer connector 64, the first substrate 34S1 and the second substrate 34S2 are stacked on one another. Before the planar member 66 is folded back at the fold-back position 68 of the interlayer connector 64, the U-phase conductor layer 33U, the V-phase conductor layer 33V, and the W-phase conductor layer 33W formed on the first substrate 34S1, and the U-phase conductor layer 33U, the V-phase conductor layer 33V, and the W-phase conductor layer 33W formed on the second substrate 34S2, are arranged in a symmetrical configuration with the fold-back position 68 interposed therebetween.

The above-described configuration in this embodiment is capable of eliminating the need for an additional manufacturing step for connecting, using the series-connecting conductor 50, the conductor layer 33 formed on the first substrate 34S1 and the conductor layer 33 formed on the second substrate 34S2. Moreover, by providing the interlayer connector 64 that connects the first substrate 34S1 and the second substrate 34S2, and by adopting a configuration in which the planar member is folded back at the predetermined fold-back position 68 on the interlayer connector 64, positional accuracy between the first substrate 34S1 and the second substrate 34S2 can be ensured. It is also acceptable for the parallel-connecting conductors 52 described above to be formed in the interlayer connector 64.

### Tenth Embodiment

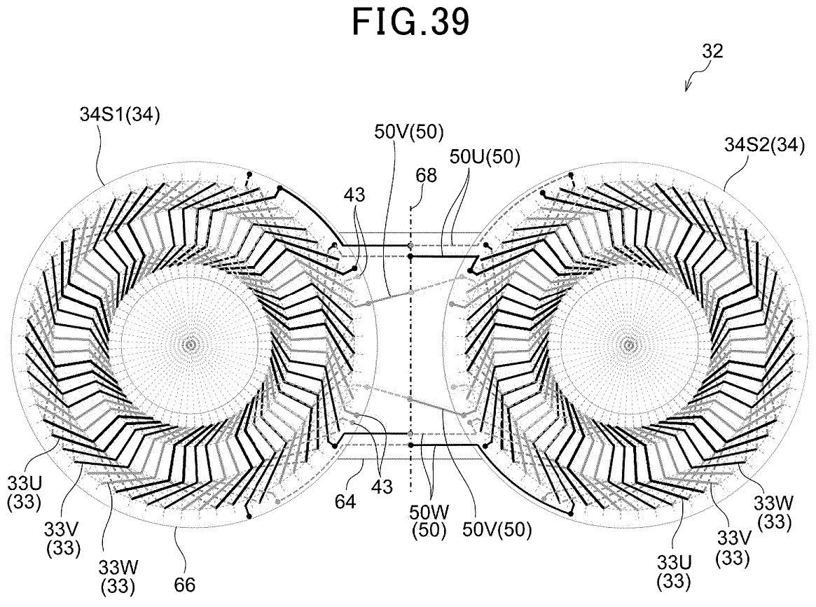

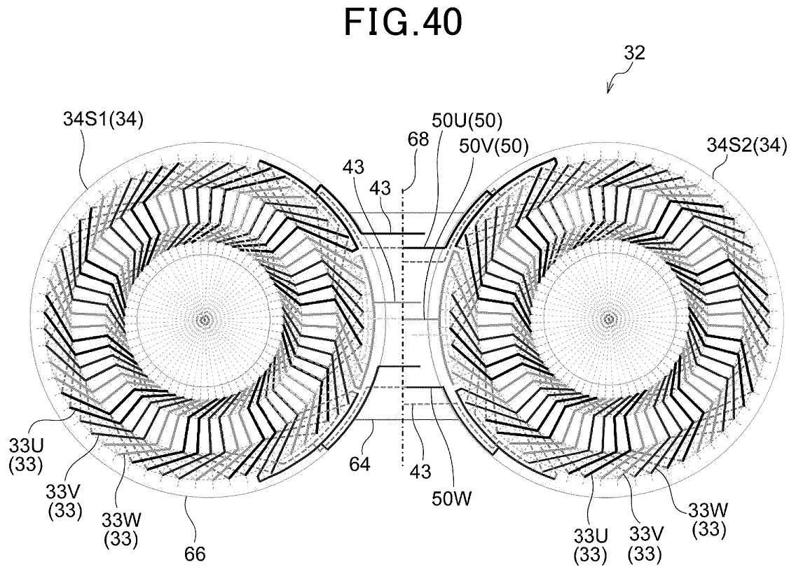

The motor according to the tenth embodiment will be described with reference to FIG. 39. The same components or parts of the motor in this embodiment as those of the motor 10 or 54 of the foregoing embodiments are denoted by the same reference numerals, and explanation thereof in detail will be omitted here.

The coil unit 32 of the motor in this embodiment, as shown in FIG. 39, includes the first substrate 34S1 and the second substrate 34S2, which are connected to each other using the interlayer connector 64. The first substrate 34S1 and the second substrate 34S2 of the coil unit 32 in this embodiment correspond, for example, to the first substrate 34S1 and the second substrate 34S2 of the coil unit 32 of the motor 58 according to the first embodiment described above. The configuration of this embodiment also eliminates the need for an additional manufacturing step for connecting, using the series-connecting conductor 50, the conductor layer 33 formed on the first substrate 34S1 and the conductor layer 33 formed on the second substrate 34S2.

### Eleventh Embodiment

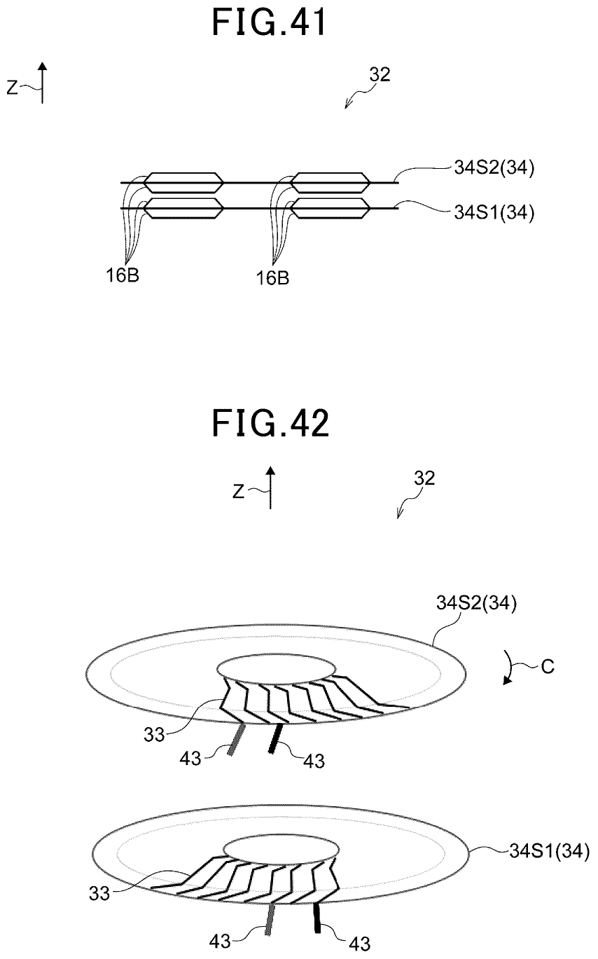

The motor according to the eleventh embodiment will be described with reference to FIGS. 40 and 41. The same components or parts of the motor in this embodiment as those of the motor 10 or 54 of the foregoing embodiments are denoted by the same reference numerals, and explanation thereof in detail will be omitted here.

The coil unit 32 of the motor in this embodiment is, as clearly illustrated in FIG. 40, configured in the same manner as the coil unit 32 of the ninth embodiment (see FIG. 38), except for the points described below. In the coil unit 32 of this embodiment, before the planar member 66 is folded back at the fold-back position 68 of the interlayer connector 64, the U-phase conductor layer 33U, the V-phase conductor layer 33V, and the W-phase conductor layer 33W formed on the first substrate 34S1, and the U-phase conductor layer 33U, the V-phase conductor layer 33V, and the W-phase conductor layer 33W formed on the second substrate 34S2, have the same pattern configuration. Then, by folding back the planar member 66 at the fold-back position 68 of the interlayer connector 64, the first substrate 34S1 and the second substrate 34S2 are stacked, as shown in FIG. 41. In the stacked state, the plurality of conductors 16B formed on the first substrate 34 and the plurality of conductors 16B formed on the second substrate 34 are arranged at the same circumferential positions. Further, in the stacked state, the plurality of conductors 16B formed on the first substrates 34 and the plurality of conductors 16B formed on the substrates 34 of another layer are overlapped with each other in the axial direction.

The configuration of this embodiment described above as well eliminates the need for an additional manufacturing step for connecting, using the series-connecting conductor 50, the conductor layer 33 formed on the first substrate 34S1 and the conductor layer 33 formed on the second substrate 3452. Moreover, by making the U-phase conductor layer 33U, the V-phase conductor layer 33V, and the W-phase conductor layer 33W formed on the first substrate 34S1 identical in pattern to the U-phase conductor layer 33U, the V-phase conductor layer 33V, and the W-phase conductor layer 33W formed on the second substrate 34S2, it is possible to suppress an increase in the design effort required for forming the conductor layers 33 on the substrates 34.

### Twelfth Embodiment

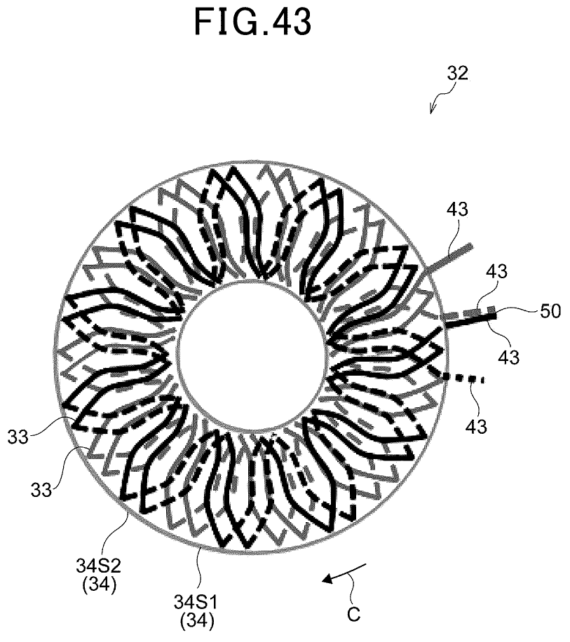

The motor according to the twelfth embodiment will be described with reference to FIGS. 42 and 43. The same components or parts of the motor in this embodiment as those of the motor 10 or 54 of the foregoing embodiments are denoted by the same reference numerals, and explanation thereof in detail will be omitted here.

The coil unit 32 of the motor in this embodiment, as illustrated in FIGS. 42 and 43, includes the first substrate 34S1 and the second substrate 34S2 which are stacked on one another. The first substate 34S1 has formed thereon a pair of input/output terminals 43, which serve as a current input path to the conductor layer 33 formed on the first substrate 34S1 and a current output path from the conductor layer 33, and extend radially outward from an outer periphery of the first substrate 34S1. The input/output terminals 43 are arranged at a given interval away from each other in the circumferential direction. Similarly, the second substrate 3452 has formed thereon a pair of input/output terminals 43 which serve as a current input path to the conductor layer 33 formed on the second substrate 34S2 and a current output path therefrom, and extend radially outward from an outer periphery of the second substrate 34S2. The input/output terminals 43 on the second substrate 34S2 are arranged at a given interval away from each other in the circumferential direction. Further, one of the input/output terminals 43 (located on one circumferential side) extending from the first substrate 34S1, and one of the input/output terminals 43 (located on the other circumferential side) extending from the second substrate 34S2, are arranged at the same circumferential position. This layout enables, in the stacked state of the first substrate 34S1 and the second substrate 34S2, the input/output terminals 43 extending from the first substrate 34S1 and 34S2 to be arranged in close proximity to each other. This facilitates the ease with which the input/output terminals 43 extending from the first substrate 34S1 are electrically connected to the input/output terminal 43 extending from the second substrate 34S2.

### Thirteenth Embodiment

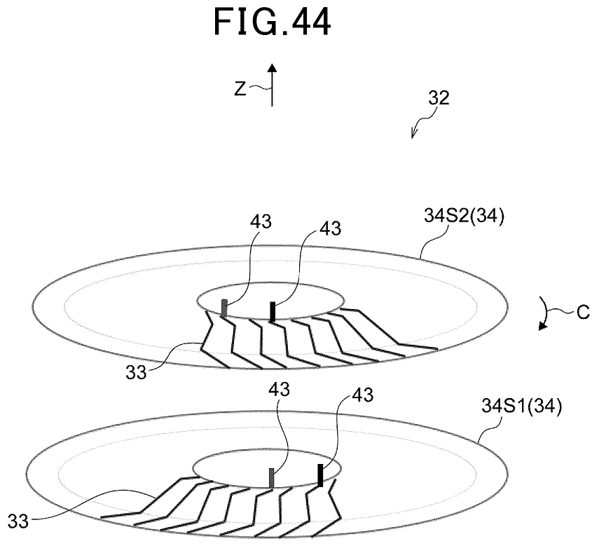

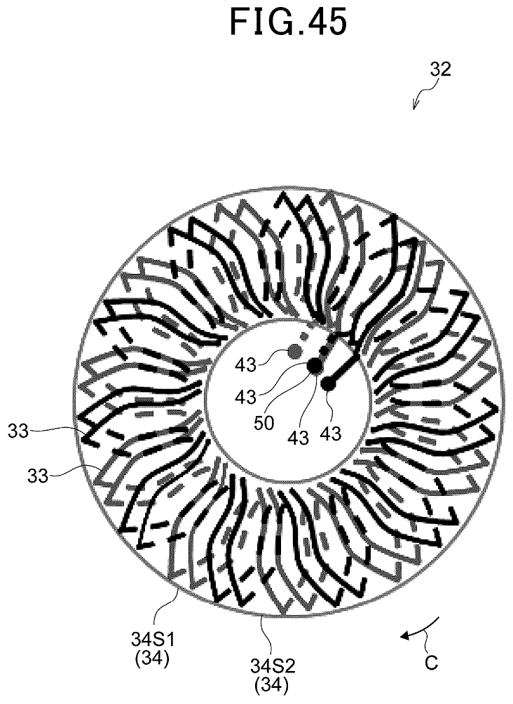

The motor according to the thirteenth embodiment will be described with reference to FIGS. 44 and 45. The same components or parts of the motor in this embodiment as those of the motor 10 or 54 of the foregoing embodiments are denoted by the same reference numerals, and explanation thereof in detail will be omitted here.

The coil unit 32 of the motor in this embodiment is, as illustrated in FIGS. 44 and 45, configured in the same manner as the coil unit 32 of the twelfth embodiment, except that the pair of input/output terminals 43 extend radially inward from an inner periphery of each of the first substrate 34S1 and the second substrate 34S2. The structure of the coil unit 32 of this embodiment also facilitates the ease with the input/output terminals 43 extending from the first substrate 34S1 are electrically connected to the input/output terminal 43 extending from the second substrate 34S2.

### Fourteenth Embodiment

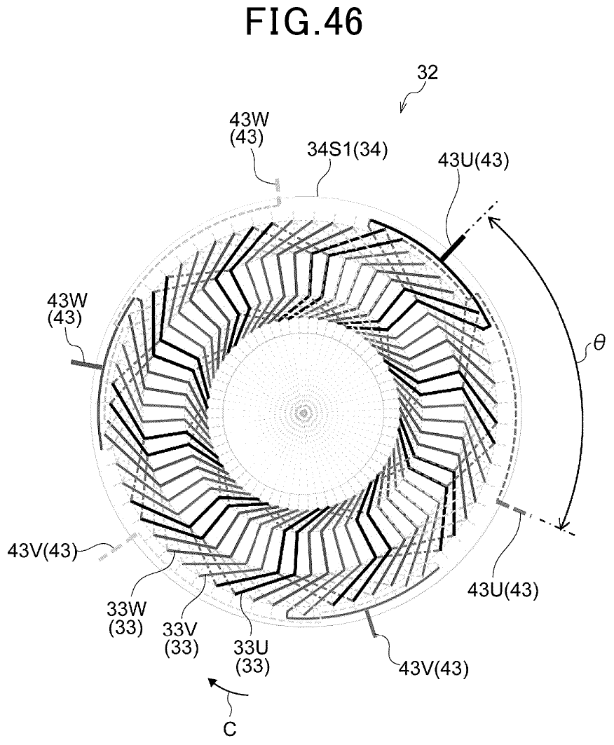

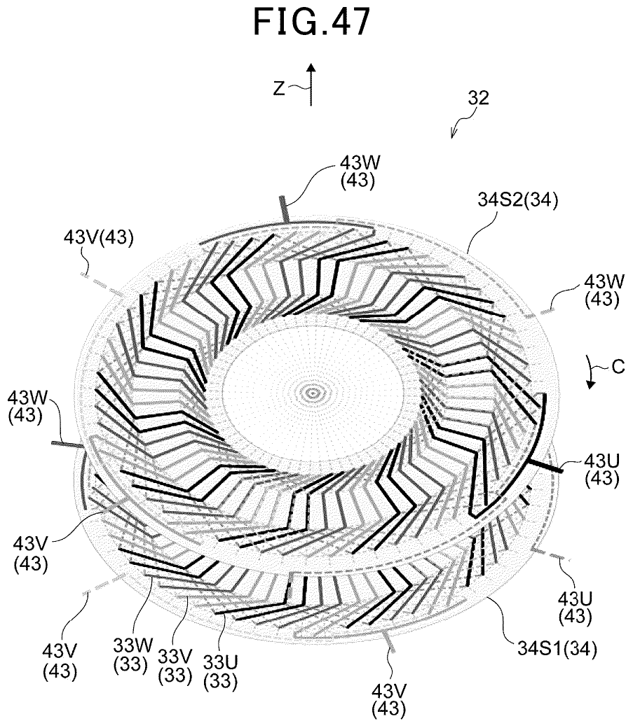

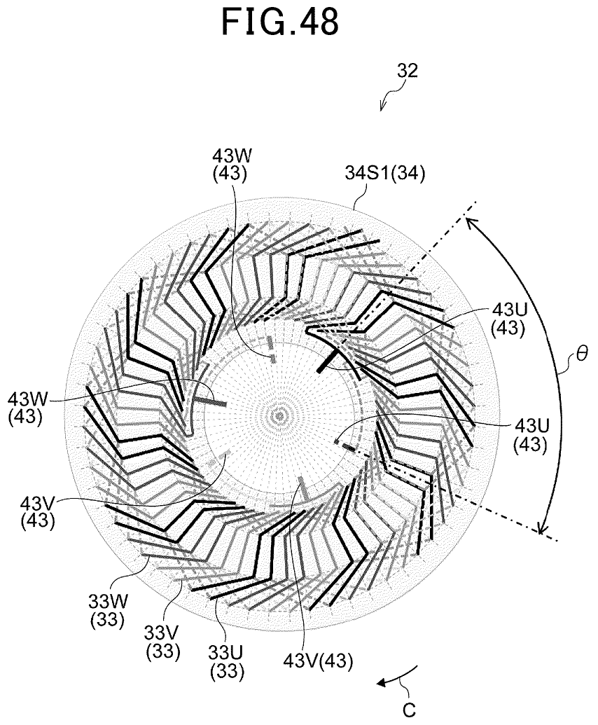

The motor according to the fourteenth embodiment will be described with reference to FIGS. 46 and 47. The same components or parts of the motor in this embodiment as those of the motor 10 or 54 of the foregoing embodiments are denoted by the same reference numerals, and explanation thereof in detail will be omitted here.

The coil unit 32 of the motor in this embodiment, as illustrated in FIGS. 46 and 47, includes the first substrate 34S1 and the second substrate 34S2 are stacked on one another. The first substrate 34S1 has formed thereon a pair of U-phase input/output terminals 43U, which serve as a current input path to the U-phase conductor layer 33U formed on the first substrate 34S1 and a current output path therefrom, and extend radially outward from an outer periphery of the first substrate 34S1. The pair of U-phase input/output terminals 43U are arranged at a given interval away from each other in the circumferential direction. As one example, the circumferential interval θ between the U-phase input/output terminals 43U is set to (360°/number of slots×2). Similarly, the first substrate 34S1 has formed thereon a pair of V-phase input/output terminals 43V, which serve as a current input path to the V-phase conductor layer 33V formed on the first substrate 34S1 and a current output path therefrom, extend radially outward from the outer periphery of the first substrate 34S1. The pair of V-phase input/output terminals 43V are arranged at a given interval away from each other in the circumferential direction. As one example, the circumferential interval θ between the V-phase input/output terminals 43V is set to (360°/number of slots×2). Furthermore, the first substrate 34S1 has formed thereon a pair of W-phase input/output terminals 43W, which serve as a current input path to the W-phase conductor layer 33W formed on the first substrate 34S1 and a current output path therefrom, extend radially outward from the outer periphery of the first substrate 34S1. The W-phase input/output terminals 43W are arranged at a given interval away from each other in the circumferential direction, and positioned on one circumferential side of the pair of V-phase input/output terminals 43V. The circumferential interval θ between the pair of W-phase input/output terminals 43W is set to (360°/number of slots×2). It should be noted that the U-phase conductor layer 33U, the V-phase conductor layer 33V, the W-phase conductor layer 33W, and pairs of U-phase input/output terminals 43U, V-phase input/output terminals 43V, and W-phase input/output terminals 43W which have configurations similar to those formed on the first substrate 34S1 are also formed on the second substate 34S2.

As can be seen in FIG. 47, the second substrate 34S2 is then rotated by 0° in one circumferential direction relative to the first substrate 34S1, and the first substrate 34S1 and the second substrate 34S2 are laminated or stacked in that positional relationship. This causes a first one of the U-phase input/output terminals 43U extending from the first substrate 34S1 and a first one of the U-phase input/output terminals 43U extending from the second substrate 34S2 to be are arranged at the same circumferential position and disposed close to each other. Similarly, a first one of the V-phase input/output terminals 43V extending from the first substrate 34S1 and a first one of the V-phase input/output terminals 43V extending from the second substrate 34S2 are arranged at the same circumferential position and disposed close to each other. Furthermore, a first one of the W-phase input/output terminals 43W extending from the first substrate 34S1 and a first one of the W-phase input/output terminals 43W extending from the second substrate 34S2 are arranged at the same circumferential position and disposed close to each other. The above-described configuration of the motor in this embodiment, therefore, facilitates connections of one of the U-phase input/output terminals 43U extending from the first substrate 34S1 to one of the U-phase input/output terminals 43U extending from the second substrate 34S2, one of the V-phase input/output terminals 43V extending from the first substrate 34S1 to one of the V-phase input/output terminals 43V extending from the second substrate 34S2, and one of the W-phase input/output terminals 43W extending from the first substrate 34S1 to one of the W-phase input/output terminals 43W extending from the second substrate 34S2.

### Fifteenth Embodiment

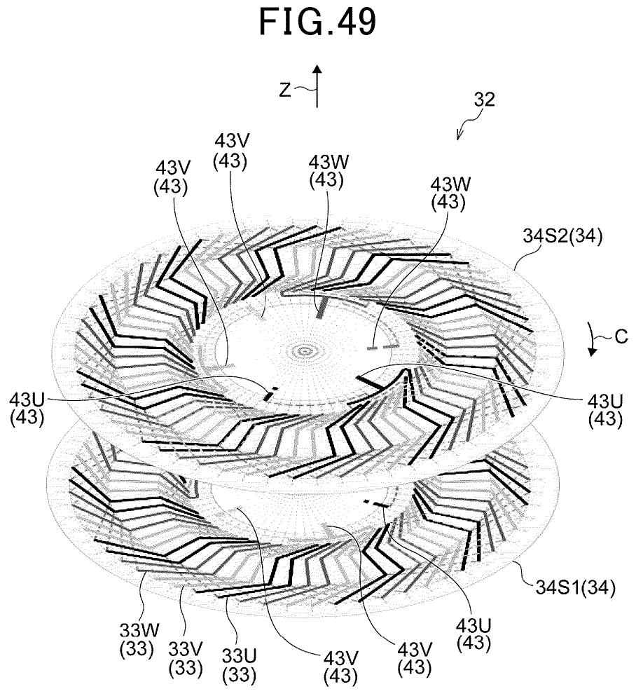

The motor according to the fifteenth embodiment will be described with reference to FIGS. 48 and 49. The same components or parts of the motor in this embodiment as those of the motor 10 or 54 of the foregoing embodiments are denoted by the same reference numerals, and explanation thereof in detail will be omitted here.

As shown in FIGS. 48 and 49, the coil unit 32 of the motor according to the present embodiment is configured in the same manner as the coil unit 32 of the motor of the fourteenth embodiment, except that a pair of U-phase input/output terminals 43U, a pair of V-phase input/output terminals 43V, and a pair of W-phase input/output terminals 43W extend radially inward from the inner periphery of each of the first substrate 34S1 and the second substrate 34S2. The configuration of the motor in this embodiment, therefore, facilitates connections of one of the U-phase input/output terminals 43U extending from the first substrate 34S1 to one of the U-phase input/output terminals 43U extending from the second substrate 34S2, one of the V-phase input/output terminals 43V extending from the first substrate 34S1 to one of the V-phase input/output terminals 43V extending from the second substrate 3452, and one of the W-phase input/output terminals 43W extending from the first substrate 34S1 to one of the W-phase input/output terminals 43W extending from the second substrate 34S2.

### Sixteenth Embodiment

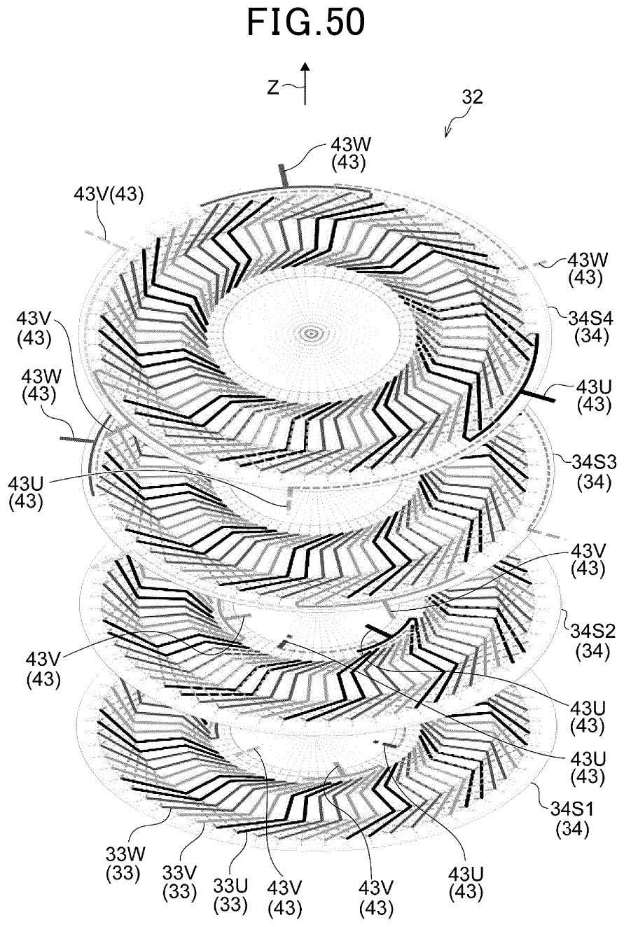

The motor according to the sixteenth embodiment will be described with reference to FIG. 50. The same components or parts of the motor in this embodiment as those of the motor 10 or 54 of the foregoing embodiments are denoted by the same reference numerals, and explanation thereof in detail will be omitted here.

The coil unit 32 of the motor according to the present embodiment, as illustrated in FIG. 50, has a configuration in which the coil unit 32 of the fourteenth embodiment described above and the coil unit 32 of the fifteenth embodiment are stake on each other. This configuration also facilitates connections of one of the U-phase input/output terminals 43U extending from the first substrate 34S1 to one of the U-phase input/output terminals 43U extending from the second substrate 3452, one of the V-phase input/output terminals 43V extending from the first substrate 34S1 to one of the V-phase input/output terminals 43V extending from the second substrate 34S2, and one of the W-phase input/output terminals 43W extending from the first substrate 34S1 to one of the W-phase input/output terminals 43W extending from the second substrate 34S2. The same applies to the third and fourth substrates 34S3 and 34S4.

Although the embodiments of the present disclosure have been described above, the present disclosure is not limited thereto, and various modifications other than those described above may of course be implemented within a scope that does not depart from the spirit of the present disclosure. In addition, all or part of the configurations of the embodiments described above may be combined with each other. For example, with respect to combinations of the configurations of the embodiments, each configuration may be appropriately selected according to the application of the motor 10 or the like. The configuration of the motor 10 or the like may also be applied to an electrical generator. Furthermore, the configuration of the present disclosure may be applied to a rotor including the coil unit 32. In the description of the embodiments of the present disclosure, numbers such as “first,” “second,” and so on have been assigned to the substrates 34, the conductor layer 33, and the series-connecting conductor 50 for convenience of explanation. Accordingly, these numbers do not mean that they must exactly correspond to the numbers described in the claims.

### Notes

### Note 1

A coil unit (32) comprising:
a plurality of base members (34) each of which is made of an insulating material and has a shape extending in a radial direction of the coil unit, the base members being stacked on one another in an axial direction of the coil unit;
a plurality of conductor layers (33) which are made of a conductive material and respectively formed on the base members;
a first series-connecting conductor (50) which connects a first conductor layer that is one of the conductor layers and formed on a first base member and a first conductor layer that is one of the conductor layers and formed on a second base member in series with each other, the first base member being one of the base members, the second base member being one of the base members;
a second series-connecting conductor (50) which connects a second conductor layer that is one of the conductor layers and formed on the first base member and a second conductor layer that is one of the conductor layers and formed on the second base member in series with each other; and
parallel-connecting conductors (52) which connect, in parallel, the conductor layers connected together by the first series-connecting conductor with the conductor layers connected together by the second series-connecting conductor.

### Note 2

A coil unit (32) comprising:
a plurality of base members (34) each of which is made of an insulating material and has a shape extending in a radial direction of the coil unit, the base members being stacked on one another in an axial direction of the coil unit;
a plurality of conductor layers (33) which are made of a conductive material and respectively formed on the base members;
a first series-connecting conductor (50) which connects, in series, a plurality of conductor layers that are some of the conductor layers, connected in parallel with each other, and formed on a first base member, to a plurality of conductor layers that are some of the conductor layers, connected in parallel with each other, and formed on a second base member, the first base member being one of the base members, the second base member being one of the base members;
a second series-connecting conductor (50) which connects, in series, a plurality of conductor layers that are some of the conductor layers, connected in parallel with each other, and formed on a third base member, to a plurality of conductor layers that are some of the conductor layers, connected in parallel with each other, and formed on a fourth base member, the third base member being one of the base members, the fourth base member being one of the base members; and
parallel-connecting conductors (52) which connect, in parallel, the conductor layers connected together by the first series-connecting conductor with the conductor layers connected together by the second series-connecting conductor.

### Note 3

The coil unit as set forth the above-described Note 1, further comprising a third base member that is one of the base member and disposed between the first base member and the second base member,
the first conductor layer formed on the first base member and the first conductor layer formed on the second base member are connected together using the first series-connecting conductor and a first conductor layer formed on the third base member, and
the second conductor layer formed on the first base member and the second conductor layer formed on the second base member are connected together using the second series-connecting conductor and a second conductor layer formed on the third base member.

### Note 4

The coil unit as set forth in the above-described Note 2, wherein the conductor layers, which are formed on the first base member located on a first axial side of a center position (70), are connected to the conductor layers formed on the second base member located on a second axial side of the center position using the first series-connecting conductor, the center position being defined by a center of a stack of the base members in an axial direction of the coil unit,
the conductor layers, which are formed on the third base member located on the first axial side of the center position (70), are connected to the conductor layers formed on the fourth base member located on the second axial side of the center position using the second series-connecting conductor, and
the conductor layers connected together by the first series-connecting conductor and the conductor layers connected together by the second series-connecting conductor are connected by the parallel-connecting conductors.

### Note 5

The coil unit as set forth in the above-described Note 2, wherein the conductor layers which are formed on the first base member located on a first axial side of a center position (70), are connected to the conductor layers formed on the second base member located on the first axial side of the center position using the first series-connecting conductor, the center position being defined by a center of a stack of the base members in an axial direction of the coil unit,
the conductor layers, which are formed on the third base member located on a second axial side of the center position (70), are connected to the conductor layers formed on the fourth base member located on the second axial side of the center position using the second series-connecting conductor, and
the conductor layers connected together by the first series-connecting conductor and the conductor layers connected together by the second series-connecting conductor are connected by the parallel-connecting conductors.

### Note 6

The coil unit as set forth in the above-described Note 1, further comprising an interlayer connector which connects a first one of the base members and a second one of the base members, and
the interlayer connector has formed thereon at least one of the first or second series-connecting conductor which connects the conductor layer formed on one of the base members to the conductor layer formed on one of the base members, the parallel-connecting conductors which connect the conductor layer formed on one of the base members to the conductor layer formed on one of the base members, and an input/output terminal which defines a current input path to the conductor layers or a current output path from the conductor layers.

### Note 7

The coil unit as set forth in the above-described Note 6, wherein the base members, which are connected by the interlayer connector, are stacked on one another in the axial direction with a portion of the interlayer connector being folded back.

### Note 8

The coil unit as set forth in the above-described Note 1, wherein an input/output terminal which defines a current input path to the conductor layer formed on a first one of the base members or a current output path therefrom and an input/output terminal which defines a current input path to the conductor layer formed on a second one of the base members or a current output path therefrom are located at a same circumferential position.

### Note 9

The coil unit as set forth in the above-described Note 8, wherein one of the base members which has the input/output terminal extending radially outward and one of the base members which has the input/output terminal extending radially inward are stacked on one another in the axial direction.

### Note 10

An armature (14) comprising the coil unit set forth in any one of the above-described Notes 1 to 9.

### Note 11

The armature as set forth in the above-described Note 10, further comprising an armature core (26) made of a soft magnetic material, and wherein the armature core is opposed to the coil unit in the axial direction with a portion of the armature core being position so as not to be disposed between the conductor layers formed on the base members.

### Note 12

A rotating electrical machine (10, 54, 56, 58, 60) comprising:
a first one of a stator (14) and a rotor (12), which includes the armature set forth in the above-described Note 10 or 11; and
a second one of the stator and the rotor which includes a magnet (18) facing the coil unit in the axial direction.

The present disclosure has been described in accordance with the embodiments; however, it is to be understood that the present disclosure is not limited to such embodiments or structures. The present disclosure also encompasses various modifications and variations within the scope of equivalents. In addition, various combinations and forms, as well as combinations and forms including only one of these elements, more than these elements, or fewer than these elements, are also within the scope and spirit of the present disclosure.

1. A coil unit comprising:
a plurality of base members each of which is made of an insulating material and has a shape extending in a radial direction of the coil unit, the base members being stacked on one another in an axial direction of the coil unit;
a plurality of conductor layers which are made of a conductive material and respectively formed on the base members;
a first series-connecting conductor which connects a first conductor layer that is one of the conductor layers and formed on a first base member and a first conductor layer that is one of the conductor layers and formed on a second base member in series with each other, the first base member being one of the base members, the second base member being one of the base members;
a second series-connecting conductor which connects a second conductor layer that is one of the conductor layers and formed on the first base member and a second conductor layer that is one of the conductor layers and formed on the second base member in series with each other; and
parallel-connecting conductors which connect, in parallel, the conductor layers connected together by the first series-connecting conductor with the conductor layers connected together by the second series-connecting conductor.

2. A coil unit comprising:
a plurality of base members each of which is made of an insulating material and has a shape extending in a radial direction of the coil unit, the base members being stacked on one another in an axial direction of the coil unit;
a plurality of conductor layers which are made of a conductive material and respectively formed on the base members;
a first series-connecting conductor which connects, in series, a plurality of conductor layers that are some of the conductor layers, connected in parallel with each other, and formed on a first base member, to a plurality of conductor layers that are some of the conductor layers, connected in parallel with each other, and formed on a second base member, the first base member being one of the base members, the second base member being one of the base members;
a second series-connecting conductor which connects, in series, a plurality of conductor layers that are some of the conductor layers, connected in parallel with each other, and formed on a third base member, to a plurality of conductor layers that are some of the conductor layers, connected in parallel with each other, and formed on a fourth base member, the third base member being one of the base members, the fourth base member being one of the base members; and
parallel-connecting conductors which connect, in parallel, the conductor layers connected together by the first series-connecting conductor with the conductor layers connected together by the second series-connecting conductor.

3. The coil unit as set forth in claim 1, further comprising a third base member that is one of the base member and disposed between the first base member and the second base member,
the first conductor layer formed on the first base member and the first conductor layer formed on the second base member are connected together using the first series-connecting conductor and a first conductor layer formed on the third base member, and
the second conductor layer formed on the first base member and the second conductor layer formed on the second base member are connected together using the second series-connecting conductor and a second conductor layer formed on the third base member.

4. The coil unit as set forth in claim 2, wherein the conductor layers, which are formed on the first base member located on a first axial side of a center position, are connected to the conductor layers formed on the second base member located on a second axial side of the center position using the first series-connecting conductor, the center position being defined by a center of a stack of the base members in an axial direction of the coil unit,
the conductor layers, which are formed on the third base member located on the first axial side of the center position, are connected to the conductor layers formed on the fourth base member located on the second axial side of the center position using the second series-connecting conductor, and
the conductor layers connected together by the first series-connecting conductor and the conductor layers connected together by the second series-connecting conductor are connected by the parallel-connecting conductors.

5. The coil unit as set forth in claim 2, wherein the conductor layers which are formed on the first base member located on a first axial side of a center position, are connected to the conductor layers formed on the second base member located on the first axial side of the center position using the first series-connecting conductor, the center position being defined by a center of a stack of the base members in an axial direction of the coil unit,
the conductor layers, which are formed on the third base member located on a second axial side of the center position, are connected to the conductor layers formed on the fourth base member located on the second axial side of the center position using the second series-connecting conductor, and
the conductor layers connected together by the first series-connecting conductor and the conductor layers connected together by the second series-connecting conductor are connected by the parallel-connecting conductors.

6. The coil unit as set forth in claim 1, further comprising an interlayer connector which connects a first one of the base members and a second one of the base members, and
the interlayer connector has formed thereon at least one of the first or second series-connecting conductor which connects the conductor layer formed on one of the base members to the conductor layer formed on one of the base members, the parallel-connecting conductors which connect the conductor layer formed on one of the base members to the conductor layer formed on one of the base members, and an input/output terminal which defines a current input path to the conductor layers or a current output path from the conductor layers.

7. The coil unit as set forth in claim 6, wherein the base members, which are connected by the interlayer connector, are stacked on one another in the axial direction with a portion of the interlayer connector being folded back.

8. The coil unit as set forth in claim 1, wherein an input/output terminal which defines a current input path to the conductor layer formed on a first one of the base members or a current output path therefrom and an input/output terminal which defines a current input path to the conductor layer formed on a second one of the base members or a current output path therefrom are located at a same circumferential position.

9. The coil unit as set forth in claim 8, wherein one of the base members which has the input/output terminal extending radially outward and one of the base members which has the input/output terminal extending radially inward are stacked on one another in the axial direction.

10. An armature comprising the coil unit set forth in claim 1.

11. The armature as set forth in claim 10, further comprising an armature core made of a soft magnetic material, and wherein the armature core is opposed to the coil unit in the axial direction with a portion of the armature core being position so as not to be disposed between the conductor layers formed on the base members.

12. A rotating electrical machine comprising:
a first one of a stator and a rotor, which includes the armature set forth in claim 10; and
a second one of the stator and the rotor which includes a magnet facing the coil unit in the axial direction.
